(19) United States
(12) Patent Application Publication
(10) Pub. No.: US 2025/0097163 A1
(43) Pub. Date: Mar. 20, 2025

(54) RESOURCE ALLOCATION FOR ACCESSING CLOUD BASED SERVICES

(71) Applicant: Oracle International Corporation, Redwood Shores, CA (US)

(72) Inventors: Ming Fang, Bellevue, WA (US); Haoran Zhou, Bellevue, WA (US); Chen Zhang, Bellevue, WA (US); Wei Gao, Bellevue, WA (US)

(73) Assignee: Oracle International Corporation, Redwood Shores, CA (US)

(21) Appl. No.: 18/741,656

(22) Filed: Jun. 12, 2024

Related U.S. Application Data
(60) Provisional application No. 63/583,167, filed on Sep. 15, 2023.
(60) Provisional application No. 63/583,169, filed on Sep. 15, 2023.

(51) Int. Cl. H04L 47/76; H04L 41/16; H04L 47/74

(52) U.S. Cl. CPC H04L 47/76; H04L 41/16; H04L 47/741

(57) ABSTRACT

The present disclosure relates to resource allocation among a plurality of clients, for using a cloud-based service, e.g., a generative artificial intelligence (GenAI) service. A first target amount of resource and a second target amount of resource can be allocated to a first client and a second client (respectively). A first and a second client, a first target amount of resource can be allocated to a first client, and a second target amount of resource can be allocated to a second client for using the service. A request can be received from a third client for allocating resources; estimating that (i) the first client is using a first subset of the first target amount and not using a second subset of first target amount, and (ii) the second client is using a third subset of the second target amount and not using a fourth subset of second target amount. It can be determined that the second subset is greater than the fourth subset. At least a portion of the second subset can be allocated as a third target amount of resource to the third client.

### CROSS-REFERENCE TO RELATED APPLICATIONS

This application claims the priority to and the benefit of U.S. Provisional Application No. 63/583,167, filed on Sep. 15, 2023, and U.S. Provisional Application No. 63/583,169, filed on Sep. 15, 2023. Each of these applications is hereby incorporated by reference in its entirety for all purposes.

### BACKGROUND

While generative artificial intelligence (GenAI) is still in its early stages of adoption, several dedicated platforms have emerged that specialize in training and generating the foundation models. Machine-learning models can be trained on big datasets and leverage deep-learning technologies. For example, a machine-learning model may use a transformer model and/or large language model (LLM). GenAI may be a significant technology as it enables the automated production of personalized content at a scale. GenAI can write code to support the development lifecycle, including a variety of unit, validation, and integration tests. Data scientists can benefit from GenAI by generating data without revealing sensitive or personal information. Synthetic data generation techniques are immensely used in the financial and healthcare sectors. For example, a human capital management (HCM) application can use GenAI to draft job description, summarize job applications and outline online learning courses.

In an example, GenAI models may be deployed in a cloud-based environment, and a plurality of cloud-based applications may avail themselves the services of these GenAI models.

### SUMMARY

Certain aspects and the features of the present disclosure relate to a secure integration of generative machine-learning or artificial intelligence (GenAI) platforms within a cloud service.

In some embodiments, a computer-implemented method is provided that includes: allocating, to respectively a first client and a second client, a first target amount of resource and a second target amount of resource for using a service; receiving, from a third client, a request for allocating resources for using the service; estimating that (i) the first client is using a first subset of the first target amount of resource and not using a second subset of first target amount of resource, and (ii) the second client is using a third subset of the second target amount of resource and not using a fourth subset of second target amount of resource; determining that the second subset of first target amount of resource is greater than the fourth subset of second target amount of resource; and allocating at least a portion of the second subset of first target amount of resource as a third target amount of resource to the third client, responsive at least in part to determining that the second subset of first amount of resource is greater than the fourth subset of second amount of resource.

Allocating at least the portion of the second subset of first target amount of resource to the third client may include: estimating that a system level amount of unallocated resource, which has not been allocated yet to any client, is less than a threshold value; and allocating at least the portion of the second subset of first amount of resource to the third client, responsive at least in part to estimating that the system level amount of unallocated resource is less than the threshold value.

The system level amount of unallocated resource may exclude (i) a first buffered amount of resource that is reserved for allocation to one or more new clients, when no other resources are available for allocation to the one or more new clients, and wherein the first buffered amount of resource is not for allocation to any active client using the service, and (ii) a second buffered amount of resource that are not to be explicitly allocated to any new or active client.

The second buffered amount of resource may at least in part act as a safety margin, to account for imprecision in resource allotment and/or resource estimation.

The threshold value may be zero.

The service may be usage of an Artificial Intelligence (AI) model.

The various amounts of resources may be measured in terms to requests per timeframe (RPT) or tokens per timeframe (TPT) to the AI model.

The various amounts of resources may be measured in terms to requests per minute (RPM) or tokens per minute (TPM) to the AI model.

The first client may be a first tenancy of a cloud environment, the first tenancy hosting a first cloud application that uses the service; the second client may be a second tenancy of the cloud environment, the second tenancy hosting a second cloud application that uses the service; the third client may be a third tenancy of the cloud environment, the third tenancy hosting a third cloud application that uses the service; and the AI model may be hosted by an AI provider tenancy of the cloud environment.

The request from the third client may be received and the third target amount of resource may be allocated during a first time period, and a method disclosed herein may further comprise: allocating, during a second time period different from the first time period and for using the service, a first modified target amount of resource and a second modified target amount of resource to respectively the first client and the second client; receiving, from a fourth client, a request for allocating resources for using the service; estimating that a system level amount of unallocated resource, which has not been allocated yet to any client, is greater than a threshold value; and allocating at least a portion of the system level amount of unallocated resource as a fourth target amount of resource to the fourth client.

The request from the third client may be received and the third target amount of resource may be allocated during a first time period, and a method disclosed herein may further comprise: receiving, from a fourth client and a fifth client and during a second time period different from the first time period, requests for allocating resources for using the service; determining that each of a plurality of active clients using the service has been allocated a minimum target resource for using the service, wherein the plurality of active clients include the fourth client and excludes the fifth client; determining that a buffered amount of resource, which is reserved for allocation to one or more new clients, has a non-zero value; allocating at least a portion of the buffered amount of resource to the fifth client; and rejecting the request that was received from the fourth client during the second time period, responsive at least in part to determining that each of the plurality of active clients using the service has been allocated the minimum target resource.

The request from the third client is received and the third target amount of resource may be allocated during a first time period, and a method disclosed herein may further comprise: allocating, during a second time period different from the first time period and for using the service, a fourth target amount of resource and a fifth target amount of resource to respectively a fourth client and a fifth client; estimating that a portion of the fourth target amount of resource, which is not being used by the fourth client, is less than a low threshold value; estimating that a portion of the fifth target amount of resource, which is not being used by the fifth client, is more than a high threshold value; selecting the fifth client for reallocation of resources to the fourth client; and reallocating a portion of the fifth target amount of resource of the fifth client to the fourth client, responsive at least in part to selecting the fifth client.

Selecting the fifth client for reallocation of resources to the fourth client may comprise: determining that among a plurality of active clients using the service, the fifth client has a highest amount of unused resource; and selecting the fifth client for reallocation of resources to the fourth client, responsive at least in part to determining that the fifth client has the highest amount of unused resource.

A method disclosed herein may further comprise: periodically checking resource allocation of a plurality of active clients using the service; determining that a first active client of the plurality of active clients has an unused resource amount that is less than a low threshold value; allocating additional resource to the at least one active client, wherein the additional resource to the at least one active client is allocated form one or more of: (i) a system level amount of unallocated resource that has not been allocated yet to any active client of the plurality of active clients, (ii) a second active client that has a highest amount of unused resource among the plurality of active clients, and/or (iii) a third active client that has a highest amount of allocated resource among the plurality of active clients.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates an exemplary overview of a system providing interactions between (i) a plurality of tenancies that are generative artificial intelligence (GenAI) clients and (ii) a GenAI provider tenancy that may be hosting a GenAI platform.

FIG. 2 illustrates an exemplary detailed structure of one or more components from a secure system architecture.

FIG. 3 illustrates an example resource allocation table maintained by a cloud environment providing GenAI services.

FIG. 4 illustrates an example resource allocation depicting resources allocated to a plurality of tenancies at a given time.

FIG. 5 illustrates a flowchart for allocating, throttling, or rejecting a resource request from a tenancy.

FIG. 6 illustrates a series of resource allocation examples by a GenAI data plane of a cloud environment.

FIG. 7 illustrates another series of resource allocation examples by a GenAI data plane of a cloud environment.

FIG. 8 is a block diagram illustrating an example method for dynamically updating a resource allocation table that is usable to allocate resources to tenancies.

FIG. 9 is a flow diagram depicting a method for allocating resources for accessing a service provided by a cloud provider, such as a GenAI service provided by the cloud provider.

FIG. 10 illustrates a simplified diagram of an example distributed system for the cloud hosting the GenAI platform.

FIG. 11 is a simplified block diagram of a cloud-based system environment in which various services of a server of the FIG. 10 may be offered as cloud services, in accordance with certain aspects.

FIG. 12 illustrates an exemplary computer system to implement certain aspects of the present disclosure.

### DETAILED DESCRIPTION

A generative artificial intelligence (GenAI) platform refers to an AI platform that specializes in generating human-like text or content using advanced natural language processing (NLP) techniques and models. These platforms may offer a range of services and capabilities including, but not limited to large language models (LLMs), application programming interface (API) access, customization, and other design facilities. GenAI platforms may provide APIs that developers and users can utilize to interact with the text generation capabilities offered by the platform. Through these APIs, users can send prompts or input texts to the platform and receive generated responses. GenAI platforms may be designed to be integrated into various applications, services, and workflows.

Generative artificial intelligence (GenAI) may include a set of techniques and algorithms that leverage enormous amount of data, including, but not limited to large language models (LLMs), to generate new content (e.g., text, images, videos, 3D renderings, audio, code). Unlike traditional machine-learning techniques that focus on analyzing the underlying dataset, the GenAI techniques may involve generation of new data samples.

In some embodiments, the disclosed system may provide cloud services for hosting GenAI models obtained through the clients, such as proprietary GenAI models of a GenAI platform and/or open-source models through a consolidated and consistent set of application programming interfaces (APIs). Cloud infrastructure can be configured to support clients in maintaining their data on-premises, providing stringent control over access and compliance with industry regulations. The integration of the GenAI platform with the cloud may enable GenAI users to access scalable resources dynamically allocated by the cloud, improving performance and responsiveness to fluctuating demands. This integration may enhance the overall efficiency and security of GenAI applications while providing users with the flexibility to adapt to evolving computational needs.

A plurality of cloud based GenAI models may be deployed within a cloud environment by the provider of the GenAI service. In an example, the cloud environment may further include a plurality of cloud customer tenancies. A tenancy is an isolated partition within the cloud environment, such that resources in different tenancies are isolated from each other unless explicitly shared. Each tenancy runs a plurality of virtual machine compute instances. A cloud customer tenancy is rented out or otherwise assigned to a cloud customer. The GenAI models may be deployed within a tenancy of the provider of the GenAI service.

Clients can access these GenAI models, to avail themselves of the GenAI service offered by these models. An example of a client may be a cloud application hosted by a tenancy. The cloud application can be a website offering GenAI query-based services. Some of the embodiments described below use tenancies as examples of clients of the GenAI service. However, the clients of the GenAI service may be tenancies, cloud applications hosted by such tenancies, applications hosted within on-premise storage of a company (e.g., outside of the cloud environment), individual user devices requesting GenAI services, and/or the like. Thus, the teachings of this disclosure are not tied to any specific type of clients availing the GenAI service, although tenancies and cloud-based applications are used as examples of such clients.

Furthermore, the clients avail themselves of a service, such as the GenAI service. However, the teachings of this disclosure may be extended beyond GenAI service, and the resource allocation techniques described below can be used to allocate resources for any type of services, such as services for other types of AI models (e.g., other than GenAI models), services for other types of cloud-based (or off-cloud) applications, and/or the like.

The provider of the GenAI service deploys a resource allocation service that allocates resources among a plurality of clients for accessing the GenAI service. In an example, the resource allocation service aims to promote fairness in allocating resources to the clients. In an example, resources are measured in terms of number of requests or number of tokens submitted by a client within a given unit of time. Tokens are the smallest unit of text that carries meaning for a LLM, such as for GenAI models. To prepare text for understanding, models use tokenization, a process that breaks down sentences or larger chunks of text into individual tokens. Each request to a GenAI model may include one or more tokens. As described below, the GenAI resources may be expressed in terms of computing capacity, a number of requests per minute (RPM), and/or a number of tokens per minute (TPM). Note that the RPM is a specific example of requests per timeframe (RPT), where the timeframe can be any appropriate time duration, such as 10 seconds, 30 seconds, 1 minute, 2 minutes, or the like. When the timeframe is 1 minute, RPT is equivalent to RPM. Similarly, TPM may be replaced by tokens per timeframe (TPT). Various examples described herein use RPM as a unit of resource, but the RPM may be replaced by RPT or TPT (e.g., with an appropriate timeframe duration), or TPM.

For the purposes of this disclosure, a new client of the GenAI service may be a client to which no resource is currently allocated and from which a request for resource allocation is being received. It may be possible that in the past (e.g., near past or distant past), the client was allocated resources for using the GenAI service—but no resource is currently allocated to the client. It may also be possible that the new client was never allocated GenAI resources before. On the other hand, an active client is a client to which resources are currently allocated.

Once a new client is allocated resources, the new tenancy transitions to becoming an active tenancy. Similarly, once an active tenancy is no longer using the GenAI service and the resources of the client are withdrawn or deallocated, the active client transitions to becoming a new client for purposes of future resource requests.

In an example, the resource allocation service receives requests for resources from the various clients (new and/or active clients of the GenAI services), and allocates resources in a fairest possible manner (or in a near fair manner) to the various clients. When the demand for resources is relatively less, the resource allocation service tries to permit as many requests as possible without restrictions to maximize the GPU usage, as GPUs are expensive and will be costly to stay idle. However, when demand for resources exceeds or near exceeds available resources, the resource allocation service has to ration resources, and divide available resources among the various clients in the fairest or near-fair manner that is practical.

In an example, the GenAI service deploys a plurality of GenAI models. A total amount of resource (such as a total RPM) that can be provided by the combination of the GenAI models being executed remains fixed, which may be based on a number of factors, such as a total number of GenAI models being executed by the GenAI service, compute power of a graphic processing unit (GPU) pool on which the GenAI models are being executed, configuration, efficiency, and/or one or more other factors associated with the GenAI models and/or the GPUs on which the models are being executed. In an example, the resource allocation service estimates the total available system level resource, which is a sum of resources that can be provided by all the deployed GenAI models.

In an example, when allocating resources to various tenancies, the resource allocation service reserves some resources as buffers. Notably, two buffer resources are reserved by the resource allocation service: (i) resources reserved as a grace buffer, and (ii) resources reserved as a reserved buffer.

Due to the periodic broadcasting of resource allocation and/or usage information among the resource allocation services across different API servers, a certain level of imprecision in the overall request count for each tenant may be possible. Additionally or alternatively, a client may request a specific resource amount but may consume slightly higher (or lower) resource amount. There may be inherent inaccuracies in keeping track of and estimating resource allocation and/or resource usage information. Accordingly, to account for this inherent inaccuracy and to ensure that the GenAI models' performance remains within the specified maximum throughput, the reserved buffer keeps a reserved resource amount, which may be a certain percentage of the total available system level resource. The reserved buffer serves as a protective margin and may be reserved for refining data synchronization and facilitating updates to the resource allocation configuration, without the intention of being utilized for incoming requests. Thus, the resources within the reserved buffer are not usually explicitly allocated to any client, although a client may consume some of the resources within the reserved buffer.

In an example, the resource allocation service may aim to provide at least some predetermined minimum amount of resource to the various clients (e.g., so as to maintain at least some basic user experience), where the minimum amount of resource to be allocated to individual clients is symbolically represented as MinX, where X is an identifier of a client. Thus, client A and client B are to be respectively assigned the minimum amount of resources MinA and MinB. In an example, the minimum amount of resources for various clients are the same, although they may be different in another example. The minimum amount of resource may be based on a service level objective (SLO) assured to a client. In an example, the grace buffer comes into play when the system limits are already utilized by active tenants, and new tenant requests are to be accommodated. Thus, if currently active tenants are allocated the bare minimum (or near minimum) target resource (e.g., MinX, where X corresponds to active clients) and a new client requests allocation of resources, resources form the grace buffer is allocated to the new client, which may allow the new client to submit a limited number of requests to sustain its fundamental user experience.

Resource allocated to a client is referred to as a target resource for the client, and is symbolically represented as TX, where X is the client index. Thus, target resource allocated to client A is TA, target resource allocated to client B is TB, and so on.

Note that a first subset of the target resource TX allocated to a client X may be used by the client X, while a second subset of the target resource TX allocated to the client X may not be used by the client X. Resource used by client X is symbolically referred to as “UX” herein. Resource allocated to, but not used by client X, is symbolically referred to as “UnX” herein. Accordingly, for a client X, (TX=UX+UnX).

In an example, the resource allocation service maintains a resource allocation table, which lists resources allocated to different clients of the GenAI service. The resource allocation table stores the target resource TX, used resource UX, and unused resource UnX for all active clients to whom resources have been allocated. The resource allocation table also stores system level unallocated resource, also denoted as “UaSys” herein. The system level unallocated resource UaSys represents resource that haven't been allocated yet, and excludes the buffered resources (such as the grace buffer and the reserved buffer).

In an example, when the GenAI data plane (such as the resource allocation service) receives one or more requests for resource from one or more clients, the GenAI data plane (such as the resource allocation service) aims to find system level unallocated RPM UaSys. If system level unallocated resource UaSys is nonzero and is sufficient to meet the demand of the new request(s), the GenAI data plane uses the system level unallocated resource UaSys to meet the demand of the new request(s).

In case the system level unallocated resource UaSys is zero or less than a threshold (e.g., all available system level resources, except for the grace and reserved buffers, have been allocated), unused resources form one or more clients with high unused resource (e.g., high UX) can be used to meet the resource demand of the new request(s). For example, unused resources allocated to the client corresponding to the highest UX across all active clients may be reallocated initially to meet the resource demand of the new request(s). Subsequently, if further resources are needed to meet the demand, then unused resources allocated to the client corresponding to the second highest UX can be used, and so on. This may result in achieving a substantially even unused resources across one or more or various active clients (such as all active clients), and results in fair or near fair resource allocation.

There may be scenarios where no (or very few) clients have unused resources (e.g., UnX is zero or close or zero for one or more, or most, or all active clients), and hence, there may not be any unallocated system level resource and/or unused client level resource. In such cases, the target resource of one or more clients may be reduced. For example, the target resource of one or more clients having high (such as highest) target resource may be reduced, and the freed-up resources may be used to meet the demand of the new requests. In an example, the target resource of various clients may be iteratively reduced, e.g., until the target resources of the clients are substantially the same. In a worst-case scenario (e.g., when the demand is relatively high), the target resource of the one or more clients may be at the minimum target limit (MinX).

In an example, when one or more (such as most or all the active clients) are operating at or near their corresponding minimum target resource limit, if a request for additional resources is received from a currently active client, such requests may be denied by the GenAI data plane.

In an example, when one or more (such as most or all the active clients) are operating at the or near their corresponding minimum target resources, if a request for resources is received from a new client (e.g., which was not active so far), resources for such request may be fulfilled by the resources within the grace buffer.

In an example, reallocation of resources may occur at least in one or more of the following scenarios: (i) a new client sends its initial request, where the reallocation is a request based reallocation, (ii) an active client has its usage reaching a certain high threshold percentage of its allocated resource (e.g., UnA is about 95% of TA, and thus, client A may need new resources), where such reallocation may be done during periodic checkup or updating of the resource allocation table, and/or (iii) a currently active client becomes inactive, where such reallocation may be done during periodic checkup or updating of the resource allocation table.

In an example, when establishing a default minimum target resource for a new client or increasing the target resource allocated to an existing active tenant, the allocation of the resources may follow an allocation order in which resources to be allocated are selected. If the required resources cannot be fully obtained from a first source of this allocation order, the remaining amount is then obtained from a second source of the allocation order, and so on. In an example, the allocation order is as follows:

### Allocation Order

1. System level unallocated RPM (UaSys),
2. Resources allocated to, but unused by, various clients (e.g., UnX for client X), such as from clients with the most unused resources to the clients with the least unused resources,
3. Used resource from active clients, from clients with the most usage to clients with the least usage.

In an example, no single client may be allowed to use higher than a threshold percentage of the total available system level resource, e.g., to prevent or at least reduce possibilities of resource hogging by one or more clients. In an example, if requests are received from more than one client, the available resources are distributed in a fair or at least near-fair manner, as described below.

In an example, a scenario may arise where the GenAI data plane has multiple active clients and one or more (such as most or all) of the active clients are fully using their allocated resources (e.g., UnX is substantially zero for all active clients), and additionally there is no system level unallocated RPM (UaSys=0), there is no unused or unallocated resource for allocation, either in the system level (e.g., UaSys) or in client level (UnX for client X). In such a scenario, the GenAI data plane may start throttling and scaling down the client target allocated resource (e.g., when additional resources are requested by active clients), as will be described below. In an example, the resource allocation table is periodically updated, e.g., to ensure that resources are fairly or near-fairly allocated among the currently active clients.

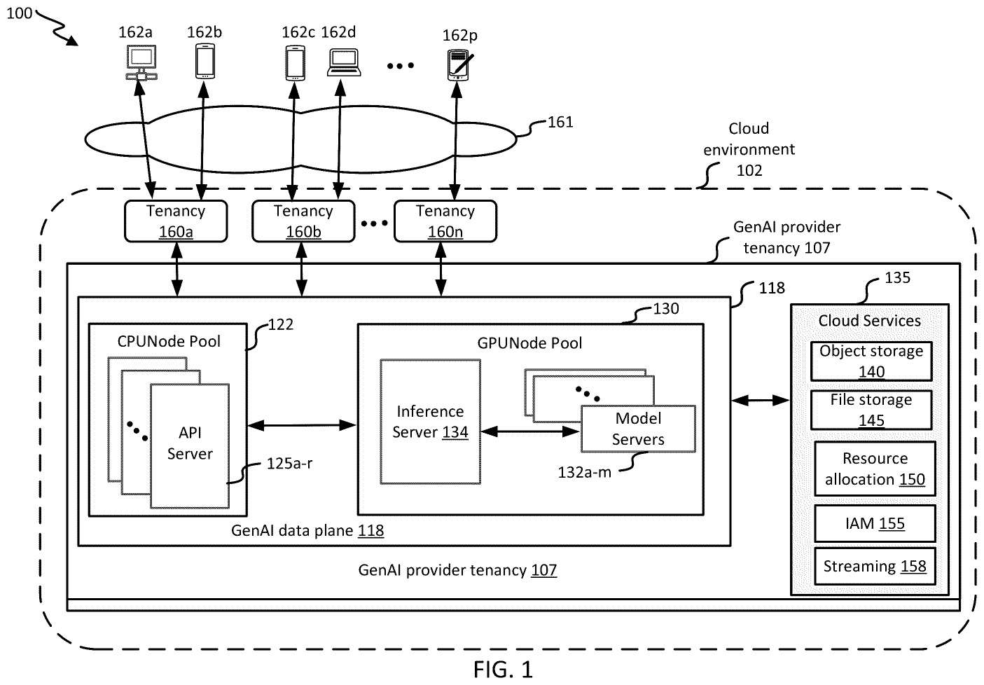

FIG. 1 illustrates an exemplary overview of a system 100 providing interactions between (i) a plurality of tenancies 160a, . . . , 160n that are generative artificial intelligence (GenAI) clients and (ii) a GenAI provider tenancy 107 that may be hosting a GenAI platform. The system 100 comprises a cloud environment 102 including the plurality of tenancies 160a, . . . , 160n and the GenAI provider tenancy 107 (also referred to herein as tenancy 107). Examples of the cloud environment 102 may be Amazon AWS, Oracle cloud infrastructure (OCI), Microsoft Azure, Google cloud platform (GCP), or a cloud environment provided by another cloud environment provider.

The tenancy 107 comprises GenAI data plane 118 integrating model servers 132a, . . . 132m for one or more GenAI platform models or open-source models and various cloud services 135. When a GenAI platform (e.g., Cohere, OpenAI, or the like) is integrated into the cloud environment 102, it becomes a part of the overall cloud system. The GenAI data plane 118 may further include a CPU (central processing unit) node pool 122 and a GPU (graphic processing unit) node pool 130. GenAI may necessitate a specialized infrastructure (e.g., GPU node pool 130) comprising GPUs interconnected with a cluster network to achieve high performance. For example, a direct memory access (DMA), such as a remote direct memory access (RDMA) super cluster network may be used to interconnect the GPUs within the GPU node pool 130. In an example, the network latency for interconnection within the GPU node pool 130 may be as low as two microseconds, or even lower.

The GenAI service offered by the cloud environment 102 may be a shared service that is shared among two or more clients. In the example of FIG. 1, the individual clients are hosted within corresponding tenancies 160a, 160b, . . . , 160n, and the tenancies 160a, 160b, . . . , 160n are considered to be the clients of the GenAI service. In general, a cloud environment comprises one or more cloud regions, where each cloud region comprises one or more cloud tenancies, such as the tenancies 106a-n and 107. In an example, each tenancy may be rented to a corresponding cloud customer, such that tenancies of different cloud customers are isolated from each other. Thus, in an example, tenancy 160a may be rented by the provider of the cloud environment 102 to a first cloud customer, tenancy 160b may be rented by the provider of the cloud environment 102 to a second cloud customer, and so on. The GenAI provider tenancy 107 may be operated by a provider of the GenAI service, which may be the provider of the cloud environment 102 in an example.

In an example, each of the tenancies 106a, . . . , 106n may share the GenAI services provided by the tenancy 107. In an example, each tenancy 106 may host one or more cloud applications, such as websites or applications that can be accessed using user devices 162. Merely as an example, in FIG. 1, user devices 162a, 162b access one or more cloud applications hosted by the tenancy 160a; user devices 162c, 162d access one or more cloud applications hosted by the tenancy 160b; user device 162p accesses the cloud applications hosted by the tenancy 160n, and so on. The number and form factor or type of the user devices illustrated in FIG. 1 are mere examples, and may vary from one example to the other.

The user devices 162a, . . . , 162p may include various types of computing devices, such as portable handheld devices, general purpose computers, such as personal computers and laptops, workstation computers, wearable devices, gaming systems, thin clients, various messaging devices, sensors or other sensing devices, and the like. These user devices may run various types and versions of software applications and operating systems (e.g., Microsoft Windows®, Apple Macintosh®, UNIX® or UNIX-like operating systems, Linux or Linux-like operating systems, such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone® or an Android® based phone), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The user devices may be capable of executing various applications, such as various Internet-related apps, communication applications (e.g., E-mail applications, short message service (SMS) applications) and may use various communication protocols. A connection between a user device 162 and a tenancy 160 may be initiated with a service request sent by a user device using a terminal, such as a web application, a mobile application, or an API.

In an example, a user device 162 may communicate with a corresponding tenancy 160 over network(s) 161. Network(s) 161 may be any type of network(s) that can support data communications using any of a variety of available protocols, including without limitation TCP/IP (transmission control protocol/internet protocol), SNA (systems network architecture), IPX (internet packet exchange), AppleTalk®, and the like. Merely by way of example, network(s) 161 can be a local area network (LAN), networks based on ethernet, token-ring, a wide-area network (WAN), the Internet, a virtual network, a virtual private network (VPN), an intranet, an extranet, a public switched telephone network (PSTN), an infra-red network, a wireless network (e.g., a network operating under any of the institute of electrical and electronics (IEEE) 1002.11 suite of protocols, Bluetooth®, and/or any other wireless protocol), and/or any combination of these and/or other networks.

The cloud application(s) hosted by each tenancy 160 may offer services provided by the GenAI provider tenancy 107 that is shared among the tenancies 10a, . . . , 160n. For example, a tenancy 160a may host a website offering search services that rely on the GenAI services, and tenancy 160b may host a website offering question and answer services that rely on the GenAI services.

In the example of FIG. 1, the clients of the GenAI provider tenancy 107 are the tenancies 160a, . . . , 160n. However, additionally or alternatively, the GenAI provider tenancy 107 may offer services directly to user devices, and in such an example, the clients of the GenAI provider tenancy 107 may be such user devices.

In general, clients of the GenAI provider tenancy 107 are appropriate components wanting to access GenAI services provided by the GenAI provider tenancy 107, and may include tenancies 160a, . . . , 160n, as illustrated in FIG. 1, and/or may include user devices (or other components/applications) wanting to access the GenAI services.

In an example, when clients set up infrastructure for the cloud based GenAI service, the service may establish a dedicated AI cluster, which includes the dedicated GPUs and an RDMA cluster network for connecting the GPUs. The GPUs allocated for a client's generative AI tasks are isolated from other GPUs thereby hosting the fine-tuning and inference workloads of clients.

The CPU node pool 122 comprises a set of nodes for resource management tasks within GenAI data plane 118 of the cloud environment 102. This may include monitoring resource usage, scheduling tasks or allocating resources on demand to enable efficient performance and resources utilization across the system. In GenAI data plane 118, the CPU node pool 122 can handle tasks related to preprocessing and managing the data before feeding into the generative models. This may include tasks, such as data cleaning, normalization, and feature extraction. The GenAI data plane 118 may further comprise API servers 125a, . . . , 125r, inference server(s) 134 and model servers 132a, . . . , 132m. These components work together in GenAI data plane 118 to process requests of clients (e.g., the tenancies 160a, . . . , 160n) and generate outputs using computational resources (e.g., GPU nodes or cloud services 135). The CPU node pool 122 can host the various API servers 125a, . . . , 125r that may be responsible for handling incoming requests from the clients (such as the tenancies 160a, . . . , 160n). These API servers 125a, . . . , 125r may also manage tasks, such as user and/or tenancy authentication, request routing, and data validation before passing the request to the appropriate components. Inference is the process of using a trained AI model to make predictions or generate outputs based on input data. In the context of GenAI, this may often involve generating new data samples, such as images, text or music based on patterns learned from the training data.

The inference server 134 may be responsible for executing trained GenAI models to perform inference tasks in real-time, while the model servers host and manage the trained models thereby providing efficient access and management capabilities. The model servers 132a, . . . , 132m may serve as a central repository where GenAI models are stored and accessed by inference server 134. When a request is received, the inference server 134 may load the appropriate model from the model servers 132a, . . . , 132m (or another storage location), process the input data through the model and return the generated output. Inference servers 134 typically run on GPU nodes to leverage the efficient computational capabilities of GPUs and for high-speed inference. GenAI data plane 118 may also leverage cloud services 135, including, but not limited to, object storage services 140, file storage services 145, resource allocation services 155, identity and access management (IAM) services 155, and/or streaming services 158. GenAI clients, such as the tenancies 160a, . . . , 160n may use the GenAI services 135 from the GenAI platform.

In an aspect, the cloud services 135 may offer resource allocation services 150 to dynamically track demand from each client and to determine how to allocate GenAI resources to various tenancies 160a, . . . , 160n based on the demand. With an increase in demand, the GenAI provider tenancy 107 may automatically scale the resources that are allocated to various tenancies 160a, . . . , 160n, as described below in detail.

In an example, a query may be received by the GenAI data plane 118 from a user device 162 via a tenancy 160 (such as from a user device 162a via the first 160a). The API servers 125a, . . . , 125r, based on the nature of a query, may forward incoming requests to inference server 134 or various model servers 132a, . . . , 132m. The model servers 132a, . . . , 132m may be serving machine-learning models from one or more GenAI platforms and/or open-sources. These model servers 132a, . . . , 132m are specialized in executing machine-learning models and natural language processing tasks. The model servers 132a, . . . , 132m may enable access over the network to other applications to send data for inference and to receive predictions or results from the models. The queries can be in the form of text, voice, or other data types, depending on the capabilities of a platform that may be using NLP models to understand and process the user queries in a user-friendly manner. The GenAI data plane 118 may analyze the text, extract the intent of its users, and identify entities that are mentioned in the queries. The GenAI data plane 118 may then generate a response to the query by using its AI model(s), such as natural language processing model. The integration with a cloud environment 102 can enable scalability in terms of computing power and memory storage thereby providing a reliable and consistent performance while executing open-sourced and/or non-open sourced GenAI models.

Seamless and dependable usage by GenAI clients (such as tenancies 160a, . . . , 160n) may be supported by various cloud services 135, dependencies, libraries, and runtime environments. IAM services 155 provided by the cloud services 135 may enable secure management of user roles, identities, and permissions within the cloud infrastructure thereby avoiding IP leakage and cross-tenancy leakage. IAM policies can be configured to control access to resources, APIs and services based on specific users or groups. This security may ensure that only authorized GenAI tenancies, users and services can interact with the GenAI platforms and its components. The authentication process can be completed by IAM 155 services providing centralized user management leveraging techniques, such as username and password validation, multi-factor authentication (MFA), and single sign-on (SSO).

ML models can be stored securely using file storage services 145 and object storage services 140 provided by the cloud environment 102. These cloud services 135 may enable persistent and secure data availability. Object storage services 140, such as those provided by Amazon S3®, Google cloud®, Microsoft Azure®, or Oracle cloud® can manage and store large volumes of heterogeneous data, structured data and/or unstructured data. The stored data can include files, documents, images, backups, etc. Object storage services 140 can provide scalable, durable, and highly available storage for data used by GenAI data plane 118 for data archiving, backup and restore, storing large datasets, training datasets, generated outputs, and content distribution (e.g., for websites and applications).

Streaming services 158, such as Amazon Kinesis can be used to ingest real-time data streams from various sources, such as sensors, social media feeds, or application logs. These streams of data can be processed by the GenAI data plane 118 to generate insights, perform analysis, or trigger automated actions in response to specific events. File storage services 145 can be used to store configuration files for model deployment, model checkpoints, auxiliary data used during inference or training processes and other resources that may be required by GenAI platform. The file storage services 145 may provide a fully managed network file storage (NFS) solution that may allow clients to create and manage file systems. It may be used when multiple computation instances need to share cloud resources and access the same set of files. This may include workloads, such as application data sharing, home directories for clients, and as a shared storage backend for applications running in a multi-tier architecture.

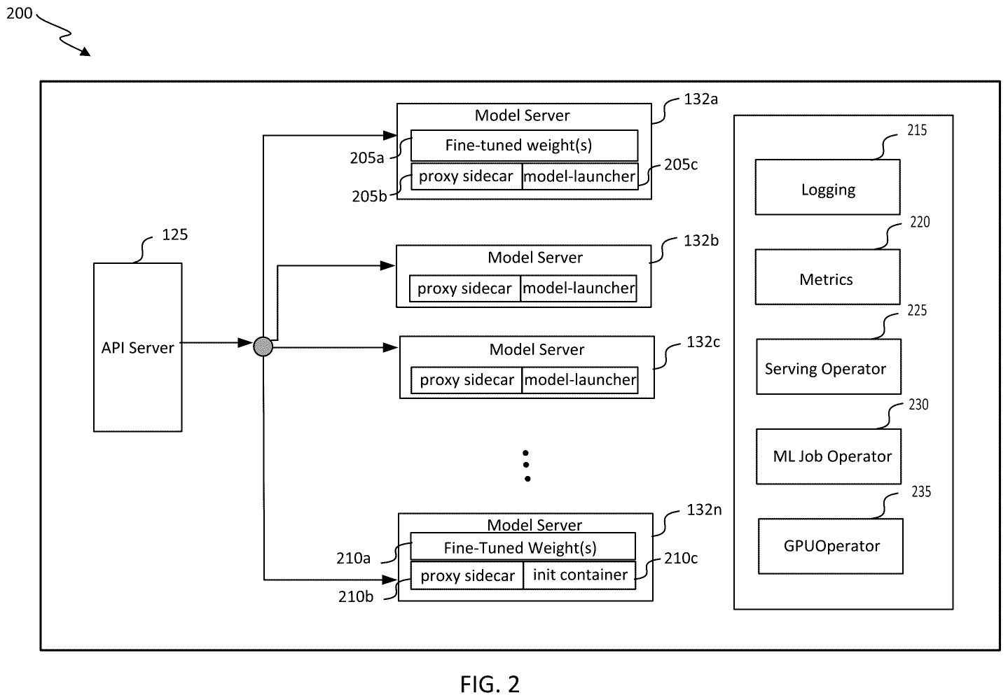

FIG. 2 illustrates an exemplary detailed structure of one or more components from a secure system architecture (e.g., such as an architecture depicted in FIG. 1). The structure of FIG. 2 may include an API server 125, a plurality of model servers 132a, . . . , 132m serving GenAI platform models (e.g., also described above with respect to FIG. 1), a logging module 215, a metrics module 220, a serving operator module 225, an ML job operator 230 and a GPU operator 235. It is worth mentioning that the model servers 132a, . . . , 132n shown in FIG. 2 are shown as an illustrative example and not limited to any specific number.

The model server 132a may include other components, such as fine-tuned weights 205a, proxy sidecar 205b and model-launcher 205c and similar components. The cloud environment 102 may allow for customization and fine-tuning of the base models for specific tasks to make them more effective for real-world enterprise use cases or GenAI clients (e.g. tenancies 160). This fine-tuning process may require expertise and collaboration. For example, a cloud, such as Oracle partnered with a GenAI platform such as Cohere to adapt and tailor their LLMs to enterprise applications. In this case, clients can use the Cohere models, their fine-tuning strategy, and other models, such as Meta's Llama 2. Fine-tuned weights 205a in a model server can be generated by retrieving learned weights of a base model corresponding to one or more first tasks or domains. These learned weights can be adjusted using a client specific training data set that may correspond to a different specific task or domain. This may enhance the performance of pre-trained machine-learning models by fine-tuning them with task-specific data thereby improving the accuracy for specific applications.

The proxy sidecar e.g., 205b and 210b is a container that may run alongside the main model-serving container within the same pod. The proxy sidecars are commonly used for load balancing of incoming requests across multiple instances of model-serving containers, traffic routing and implementing features like circuit breaking and retries. An init container 210c is an additional container in a pod that is responsible for initialization tasks that may be required for setting up environment or preparing data before the main container starts. For a model server, an init container 210c can be used for downloading pre-trained models or model artifacts from a storage location. The regular container can be selectively started when the init container 210c is running. The init container 210c in a pod is to run and complete before any other application containers in that pod start. The model-launcher e.g., 205c and 210c may load, initialize, and serve ML models within model-serving containers. It may load the pre-trained models, or the model artifacts downloaded by init container 210c into memory, initialize any required dependencies or libraries, and expose an endpoint or API for serving inference requests.

The model servers 132a, . . . , 132n may leverage other cloud services 135 for compliance with industry regulations to secure clients' data and interactions with the models from open-source and GenAI platform. These services may include a logging module 215, metrics services 220, serving operator 225, ML job operator 230, and GPU operator 235. The logging module 215 may capture and store logs that can be generated by various services and components in the cloud 107. It may perform tracking and monitoring activities, diagnosing issues, and enabling compliance with auditing and security requirements. The logs may include information related to model inference, resource utilization, and access control etc. The metrics services 220 may monitor the system performance, providing efficient resource utilization. It may collect, store, and provide insights into different performance metrics and statistics related to different machine-learning models and other cloud resources. It may allow users to monitor the behavior, health, and efficiency of the deployed models and infrastructure. Metrics 220 may include customer metrics (which tenancy calls what API at what time, etc.), application metrics (response code, latency, etc.), host metrics (memory usage, CPU usage, etc.), k8s metrics (pod count, pod health, scaling, etc.), GPU metrics (health, memory usage, etc.) and model serving metrics (model response code, model response latency, etc.).

The serving operator 225 is a cloud component or service that may facilitate the deployment and management of machine-learning (ML) models for performing real-time inference in a cloud 107. It may automate tasks related to model serving, including scaling the inference service based on demand, load balancing, and routing requests to the appropriate model version or instance. The other cloud services, such as ML job operator 230 may be responsible for managing the lifecycle of machine-learning jobs in the cloud 107. It may enable clients to create, schedule, and orchestrate ML workflows, including data preparation, model training, and model validation, testing and evaluation. It may also handle complex ML tasks, such as training new models and updating the existing ones. These operators interact with graphics processing units (GPU) operator 235 for executing computationally intensive tasks. GPU operators 235 may manage the allocation and utilization of GPUs in the cloud 107 for AI and ML workloads that use high computational power. They can be used to reduce the training time of deep learning models and inference. The GPU operator 235 may also enable provision and configuration of GPU resources to the GenAI clients 105 for the ML tasks by optimizing performance and resource utilization.

The two main components of GenAI data plane may be an API server 125 and inference server 134. The core responsibilities of the API server 125 may include forwarding users' requests (e.g., text generation and embedding requests) to the inferencing component and returning responses to users. The API server 125 may also perform rate limiting for requests and authorization by leveraging cloud IAM service 155 on incoming requests. The rate limiting may include regular requests per minute (RPM)-based rate limiting, as well as custom token-based rate limiting (e.g., tokens per minute or TPM), as described below in further detail. The API server 125 may integrate the limits service to override default limits for a specific tenancy and moderate content in incoming request and outgoing response for avoiding toxic content generation. Content moderation may be applied in multiple stages of the GenAI training and inference lifecycle. For example, the sensitive or toxic information may be removed from training data before the model is trained or fine-tuned. In some instances, models can be trained to not give responses about sensitive or toxic information, such as a user's prompt, “how to commit crimes or engage in unlawful activities.” In other instances, filtering can be applied, or response generation can be halted if the results include undesirable content. In this way, profane text may be rejected by an API server 125 resulting in an exception.

Additionally, the API server 125 may query model metastore to retrieve model metadata and send metering and billing information to bling service after a successful completion of a user request. The API server 125 may also emit metrics and logs where the metrics may include customer metrics, application metrics, host metrics, k8s metrics, GPU metrics and model serving metrics.

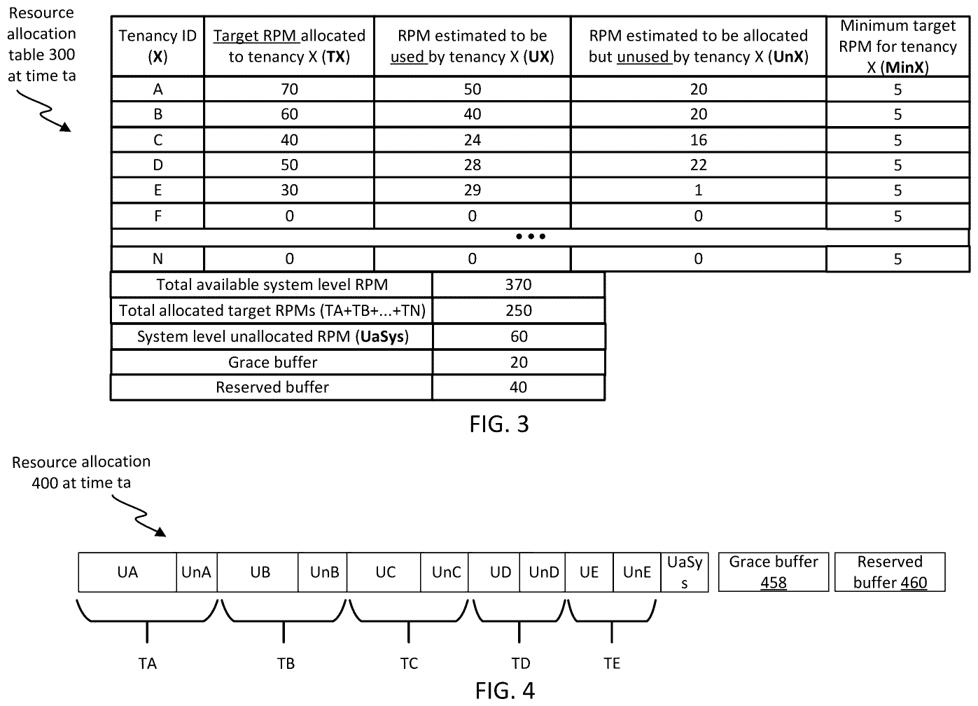

FIG. 3 illustrates an example resource allocation table 300 maintained by the cloud environment 102. FIG. 4 illustrates an example resource allocation 400 depicting resources allocated to a plurality of tenancies at a given time ta. The resource allocation 400 of FIG. 4 is a graphical representation of how resources are allocated in accordance with the example resource allocation table 300 of FIG. 3. FIGS. 3 and 4 will be described in unison.

In an example, the resource allocation table 300 is maintained by the resource allocation service 150 (see FIG. 1). Note that various example resource amounts (e.g., in the form of RPMs) are illustrated in FIG. 3 and described below, and these resource amounts are mere examples.

The resource allocation table 300 (also referred to as table 300) lists resources allocated to different clients of the GenAI provider tenancy 107. The clients of the GenAI provider tenancy 107 are various tenancies 160a, . . . , 160n in the example system 100 of FIG. 1, but can also be user devices (or other entities, such as one or more application programs) in another example. The table 300 is described assuming various tenancies to be the clients of the GenAI provider tenancy 107, but other types of clients may also be possible. In table 300, the resources of the GenAI provider tenancy 107 are assumed to be RPMs, but other types of resources of the GenAI provider tenancy 107 may also be possible, such as TPMs.

The table 300 of FIG. 3 includes identifiers of the tenancies (“tenancy ID” in FIG. 3). For purposes of simplicity, the tenancies are identified as tenancy A, tenancy B, and so on, and these tenancies may be one or more of the tenancies 160a, 160n, 160c, . . . , 160n of FIG. 1. The tenancy ID is generally expressed herein as “tenancy X”, where “X” is the identifier of the tenancy. A reference to a tenancy X can be for any of the tenancies A, . . . , N, and thus, when referring generally to a tenancy X, the label X can be any of A, B, . . . , N. Note that in real implementation, the tenancy ID may be in binary, hexadecimal, or another appropriate form.

The GenAI resources may be expressed in terms of GPU computing capacity, a number of requests per minute (e.g., number of RPMs) to be allocated to the tenancy 160, and/or a number of tokens per minute (e.g., number of TPMs) to be allocated to the tenancy 160. Some of the below description refers to GenAI resources as being RPMs, which may be allocated fairly among the tenancies 160a, . . . , 160n. However, in another example, GenAI resources may also be expressed in terms of TPMs.

Note that the RPM or requests per minute is an example of requests per timeframe (RPT), where the timeframe can be any appropriate time duration, such as 10 seconds, 30 seconds, 1 minute, 2 minutes, or the like. When the timeframe is 1 minute, RPT is equivalent to RPM. Various examples described herein use RPM as a unit of resource, but the RPM may be replaced by RPT (e.g., with an appropriate timeframe duration). Similarly, TPM may be replaced by tokens per timeframe (TPT).

As described below, the GenAI provider tenancy 107 (such as the resource allocation services 150) receives requests for resources from one or more of the tenancies A, . . . , N. Individual ones of the tenancies A, . . . , N transmits such requests to the GenAI provider tenancy 107, based on demand for the GenAI service within the tenancy. For example, individual tenancies receive requests for GenAI services from corresponding user devices 162. Based on such user demands, and in order to fulfill such demand, individual tenancies requests resources from the GenAI provider tenancy 107.

For example, assume a scenario where the tenancy A hosts a first website that currently has requests for GenAI service from 50 user devices, and the tenancy B hosts a second website that currently has requests for GenAI service from 100 user devices (these numbers are mere examples, and in real implementation these numbers are likely going to be different, such as higher). Accordingly, the tenancy A is likely to request less amount of resources and tenancy B is likely to more number of resources from the GenAI provider tenancy 107. As described above, the resources are measured in RPM (although RPT, TPM, or TPT may also be used). Accordingly, based on the current demand, the tenancy A may request 100 RPMs of resources from the GenAI provider tenancy 107, and the tenancy B may request 200 RPMs of resources from the GenAI provider tenancy 107 (e.g., based on the example demands described above).

Of course, the demand for GenAI services within each tenancy fluctuates with time, and are dynamic in nature. Thus, after some time (such as after 15 seconds, or 30 seconds, or a minute), tenancy A and tenancy B may have request for GenAI service from 20 user devices and 200 user devices, respectively. Accordingly, at that time, the tenancy A may request only 40 RPMs of resources from the GenAI provider tenancy 107, and the tenancy B may request 400 RPMs of resources from the GenAI provider tenancy 107. Thus, requests for resources received from various tenancies may change dynamically.

In yet another example, a GenAI providing website or service hosted by a tenancy may be temporarily or semi-permanently down or out of service, and hence, such a tenancy may request zero RPMs of resources from the GenAI provider tenancy 107.

In an example, the resource allocation service 150 may receive such requests for resources from the various tenancies, and allocate resources in a fairest possible manner (or in a near fair manner) to the various tenancies. When the demand for resources is relatively less, the GenAI provider tenancy 107 can provide the requested resources to the various tenancies. However, when demand for resources exceeds or near exceed available resources, the GenAI provider tenancy 107 has to ration resources, and divide resources among the various tenancies in the fairest or near-fair manner that is practical or possible.

In an example, a total amount of resource (such as a total RPM) that can be provided by each GenAI model being executed remains fixed because the number of GPUs provisioned to the service tenancy is relatively stable and it takes a long time to allocate newly acquired GPUs. Note that the total number of GenAI models being executed by the GenAI provider tenancy 107 is dictated by a number of GPUs available to run the models. Also, a number of RPMs that a model can handle may be based on the compute power, configuration, efficiency, and/or one or more other factors associated with the GenAI models and/or the GPUs on which the models are being executed. Accordingly, the total amount of resource (such as the total RPM) that can be provided by each GenAI model remains fixed, and is based at least in part on the GPUs that are available and have been provisioned to run the GenAI service.

In another example, the total amount of resource (such as the total RPM) that can be provided by each GenAI model may vary slightly, based on a complexity of the requests, but an average total amount of resource that can be provided by each GenAI model over a period of time may not fluctuate significantly with the complexity of individual requests provided to a model.

The GenAI provider tenancy 107 may desire to provide at least some predetermined minimum amount of resource to the various tenancies (e.g., so as to maintain at least some basic user experience). In an example, it may be difficult to predict how many tenants will send requests during a given time frame. In an example, the GenAI provider tenancy 107 (such as the resource allocation service 150) may aim to achieve multi-tenancy fairness in allocating resources, while aiming to maximize or at least increase utilization of the GenAI services provided by the GenAI provider tenancy 107.

As described below in detail, in an example, the resource allocation service 150 aims to maximize or at least increase utilization of the GenAI services to the extent possible. In an example, the resource allocation service 150 aims to prioritize initial requests from a new tenancy requesting service from the GenAI provider tenancy 107 (e.g., over prioritizing requests from existing tenancy to increase resource allocation). In an example, the resource allocation service 150 aims to provide a minimum throughput limit for active tenancies (e.g., tenancies that are currently receiving GenAI services), to the extent possible. In an example, the resource allocation service 150 aims to avoid a few (such as one or more) tenancies dominating and consuming a majority of the GenAI resources.

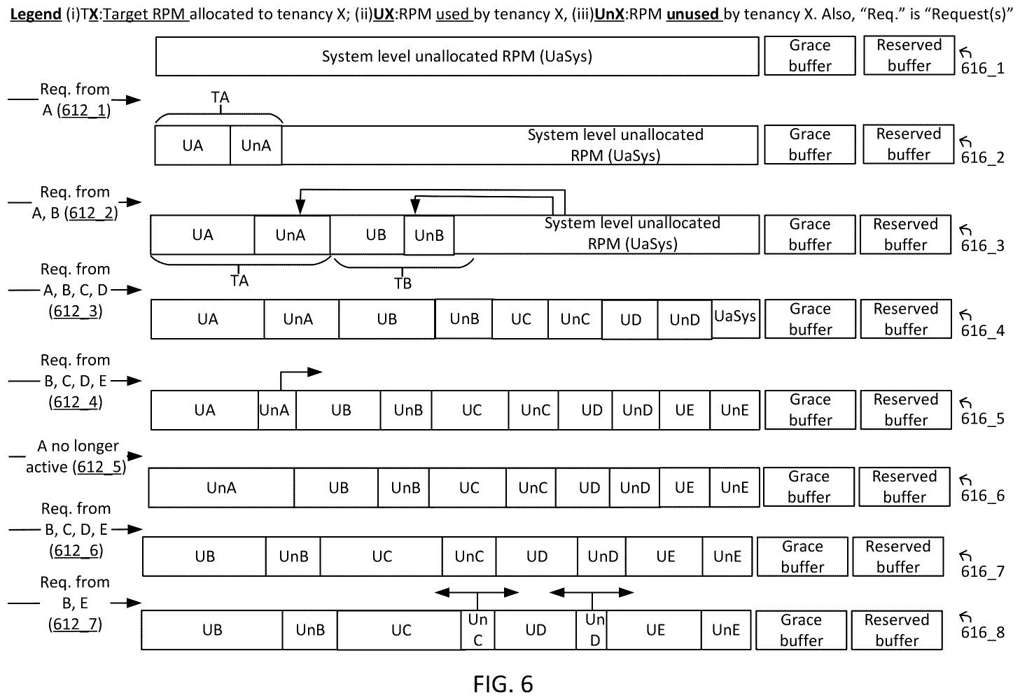

For the purposes of this disclosure, a new tenancy may be a tenancy to which no resource is currently allocated and from which a request for resource allocation is being received. It may be possible that in the past (e.g., near past or distant past), the tenancy was allocated resources for using the GenAI service—but no resource is currently allocated to the tenancy when a request for resource is received from the tenancy. Examples of new tenancies include tenancies C and D at requests 612_3 of FIG. 6 described below.

On the other hand, an active tenancy is a tenancy to which resources are currently allocated. For example, the active tenancy can request additional resources. Examples of active tenancies include tenancies A and B at requests 612_3 of FIG. 6 described below.

Once a new tenancy is allocated resources, the new tenancy transitions to becoming an active tenancy. Similarly, once an active tenancy is no longer using the service and the resources of the tenancy are withdrawn or deallocated, the active tenancy transitions to becoming a new tenancy for purposes of future resource requests.

As described above, each GenAI model being executed within the GenAI data plane 118 has a specific throughout, which may be based on one or more of hardware infrastructure (e.g., GPU computing capacity), model batch size, and/or the number of input tokens processed by individual models. In an example, the inference server 134 estimates the total available system level RPM, which is the combined throughput of all instances of the GenAI models running within the GenAI Data Plane 118. In an example, the total available system level resource (such as total available system level RPM) that may be provided by the GenAI data plane 118 may be estimated as follows:

$$Total available system level resource = throughput of individual models * number of GenAI models running within the GenAI Data Plane 118. \qquad Equation 1$$

In the example of FIG. 3, the total available system level resource (also referred to herein as “total system level throughput” or “total available system level RPM”) is assumed to be 370 RPMs. This is the total or maximum possible throughput of the GenAI system that the GenAI data plane 118 may provide.

In an example, when allocating resources to various tenancies, the resource allocation service 150 reserves some resources as buffers. Notably, two buffer resources are reserved by the resource allocation service 150: (i) resources reserved as a grace buffer 458, and (ii) resources reserved as a reserved buffer 460 (these buffers are listed in FIG. 3 and symbolically illustrated in FIG. 4). The labels “grace buffer” and “reserved buffer” are mere examples, and these buffered resources (or preserved resources that are generally not allocated, and may be allocated under specific situations described below) may be labelled using different labels (such as first and second buffers, respectively). Note that the grace buffer 458 and/or reserved buffer 460 may not be physical buffer memories, and rather, these buffers represent unallocated or buffered resources that are preserved for specific situations described below.

In an example, a first percentage of the total available system level resource may be reserved as the grace buffer 458, and a second percentage of the total available system level resource may be reserved as the reserved buffer 460. In FIG. 3, of the 370 total available system level RPM, 20 RPM is reserved as the grace buffer 458, and 40 RPM is reserved as the reserved buffer 460, merely as examples.

In an example, resource allocation decisions may be made by different API servers jointly, or separately. For example, a copy of the resource allocation table 300 may be stored or cached in different API servers, based on which the resource allocation services 150 within the API servers can independently undertake resource allocation decisions. The cached resource allocation table 300 within the different API servers may be updated at periodic or aperiodic intervals (such as every 5 seconds, or every 10 seconds, or every 20 seconds, or every 30 seconds).

Due to the periodic broadcasting of resource allocation and/or usage information among the resource allocation services 150 across different API servers, a certain level of imprecision in the overall request count for each tenant may be possible. Additionally or alternatively, a tenancy may request a specific RPM but may consume slightly higher (or lower) RPM. There may be inherent inaccuracies in keeping track of and estimating resource allocation and/or resource usage information. Accordingly, to account for this inherent inaccuracy and to ensure that the GenAI models' performance remains within the specified maximum throughput, the reserved buffer 460 keeps a reserved resource amount, which may be a certain percentage of the total available system level resource. The reserved buffer 460 serves as a protective margin and may be reserved for refining data synchronization and facilitating updates to the resource allocation configuration, without the intention of being utilized for incoming requests. Thus, the resources within the reserved buffer 460 are not usually explicitly allocated to any tenancy (although a tenancy may consume some of the resources within the reserved buffer 460, without such portion being explicitly allocated to the tenancy, and as an overflow control).

A service level objective (SLO) is a minimum agreed-upon performance target for a particular service over a period of time. For example, a customer associated with a tenancy 160 and a provider of the GenAI data plane 118 may agree on an SLO, which may be a minimum target RPM for the tenancy. In FIG. 3, the minimum target resource (such as minimum target RPM) for a tenancy X is referred to as “MinX”. Merely as an example, MixX=5 for X=A, B, . . . , N, as illustrated in the resource allocation table 300. Note that the minimum target resources MinX (where X is the tenancy ID for various tenancies) for various tenancies may have static values, and may not usually change with time (e.g., unless there is an agreement between a customer associated with a tenancy 160 and a provider of the GenAI data plane 118).

In an example, the total available system level RPM can be estimated using equation 1, and there may be inherent inaccuracies in such an estimation (e.g., as the throughput of individual models may not be accurately estimated, as the actual throughput depends on several factors, such as GPU hardware infrastructure, model batch size, the number of input tokens processed, etc.). In an example, to ensure that the GenAI service meets the desired user experience, a throughput threshold for the GenAI service may be estimated through experimentation. Crossing this threshold may result in a downgrade of user experience, causing requests to queue and be processed for longer periods than anticipated. In an example, the above-described grace buffer 458 serves as an extra capacity that the GenAI data plane 118 can utilize, e.g., when the GenAI data plane 118 may no longer meet the service SLO (e.g., the minimum target RPMs for various tenancies), without risking a model crash.

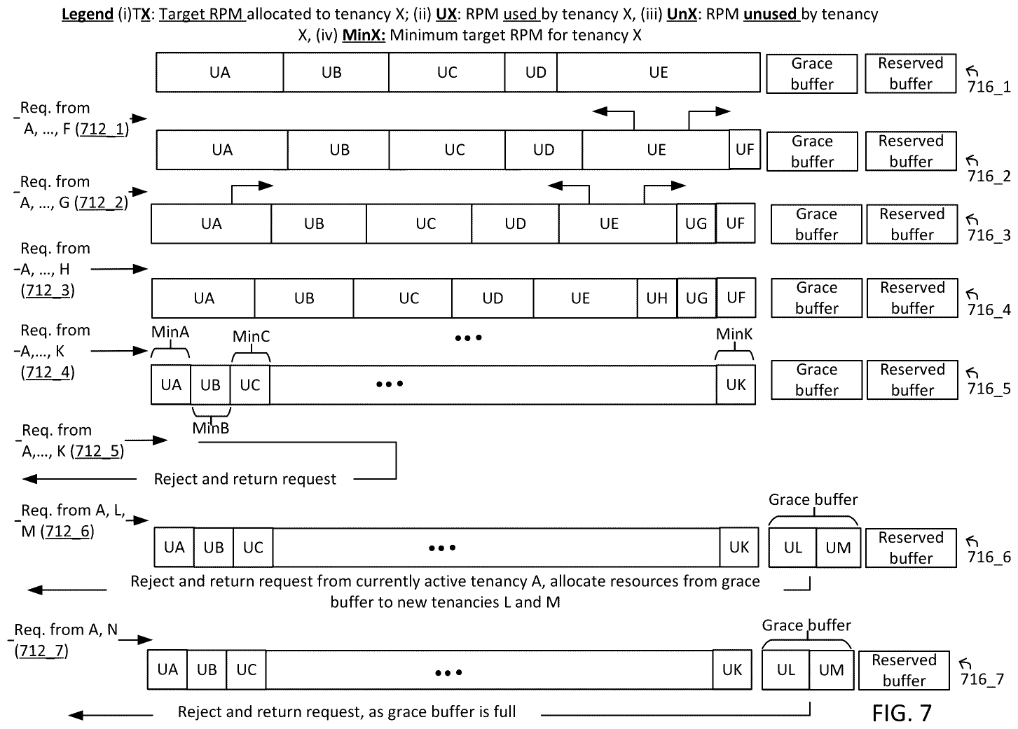

Thus, as described below, the grace buffer 458 comes into play when the system limits are already utilized by active tenants, and new tenant requests are to be accommodated. Thus, if currently active tenants are allocated the bare minimum (or near minimum) target resource (e.g., MinX, where X corresponds to active tenancies) and a new tenancy requests allocation of resources, resources form the grace buffer 458 is allocated to the new tenancy, which may allow the new tenancy to submit a limited number of requests to sustain its fundamental user experience. Thus, in an example, the grace buffer 458 is used to maintain the SLO or the minimum target RPM, and may not be used otherwise, as described below (e.g., with respect to FIG. 7).

In an example, the size of the grace buffer 458 may be at least 2×, or 3×, or 4×, or 5× or higher than the minimum target RPM for individual tenancies. As described above, the grace buffer 458 has a size of 20 RPMs in the FIG. 3, merely as an example.

FIG. 3 also illustrates a target resource (such as target RPM) allocated to a tenancy X (TX), where X can be A, B, . . . , or N. Thus, for tenancy A, the target RPM is TA. The target RPM TX is the total RPM allocated specifically to the tenancy X. Note that a first subset of the target RPM TX allocated to the tenancy X may be used by the tenancy X, while a second subset of the target RPM TX allocated to the tenancy X may not be used by the tenancy X. The GenAI data plane 118 (such as the resource allocation service 150) may estimate the RPM used by tenancy X, which is referred to as “UX” herein. Alternatively (or additionally), the GenAI data plane 118 (such as the resource allocation service 150) may estimate the RPM not used by tenancy X, which is referred to as “UnX” herein.

Thus, for a tenancy X, the following holds:

$$Target RPM allocated to tenancy X ( TX ) = RPM estimated to be used by tenancy X ( UX ) + RPM estimated to be allocated but unused by tenancy X ( UnX ) . \qquad Equation 2$$

Thus, equation 2 states that TX=UX+UnX. If any two of Tx, Ux, and UnX is known and/or estimated by the GenAI Data Plane 118, the third of Tx, Ux, and UnX may be calculated using equation 2.

In an example, at any given point in time, the GenAI data plane 118 (such as the resource allocation service 150) knows (i) the UX that each tenancy uses in the past timeframe (e.g., this data may have some lagging), (ii) the target RPM TX assigned to each tenancy. From this, unused RPMs UnX for each tenancy can be determined (UnX=TX−UX).

Resources (such as RPMs) estimated to be used by tenancy X are also referred to herein as used resource (such as used RPMs) of tenancy X or tenancy X used resource (or tenancy X used RPM). As described above, the used resource of tenancy X is represented herein as “UX”.

Similarly, resources (such as RPMs) estimated to be allocated but unused by tenancy X are also referred to herein as unused RPMs of tenancy X or tenancy X unused RPMs. As described above, the unused resource of tenancy X is represented herein as “UnX”.

Example values of the used RPM UX and the unused RPM UnX for various tenancies are illustrated in FIG. 3. For example, at time ta, 70 RPM is allocated to tenancy A (TX=70), of which the tenancy A is estimated to use 50 RPM (UA=50), and the remaining 20 RPM is not used by the tenancy A (UnA=20). Similar RPM values are also depicted for tenancies B, . . . , E. In the table 300, the tenancies F, . . . , N have zero allocated target RPM. For example, these tenancies may not be in service (or may not yet be in service). All RPM values depicted in FIG. 3 are mere examples.

The table 300 also depicts system level unallocated resources (such as system level unallocated RPMs), also denoted as “UaSys” herein. The system level unallocated resources represent resources that haven't been allocated yet, and excludes the resources buffered as the grace buffer 458 and the reserved buffer 460. The system level unallocated resources can be estimated as follows:

$$System level unallocated RPM ( UaSys ) = Total available System level RPM - Total allocated target RPMs to various tenancies - capacity of grace buffer - capacity of reseved buffer . \qquad Equation 3$$

For example, the total available system level RPM in FIG. 3 is 370. The total allocated target RPMs is the sum of target RPMs allocated to various tenancies, and is given by (TA+TB+ . . . +TN). In the table 300, the total allocated target RPMs is (70+60+40+50+30)=250. The grace buffer and the reserved buffer have capacities of 20 and 40, respectively. Accordingly, the system level unallocated RPM (UaSys) is 370−250−20−40=60, as illustrated in FIG. 3.

In an example, when the GenAI data plane 118 (such as the resource allocation service 150) receives one or more requests for resource from one or more tenancies, the GenAI data plane 118 (such as the resource allocation service 150) aims to find system level unallocated RPM UaSys. If system level unallocated RPM UaSys is nonzero and is sufficient to meet the demand of the new request(s), the GenAI data plane 118 uses the system level unallocated RPM UaSys to meet the demand of the new request(s).

In case the system level unallocated RPM UaSys is zero (e.g., all available system level resources, except for the grace and reserved buffers, have been allocated), unused resources form one or more tenancies with high unused RPM (e.g., high UX) can be used to meet the resource demand of the new request(s). For example, unused resources allocated to the tenancy corresponding to the highest UX across all active tenancies may be reallocated initially to meet the resource demand of the new request(s). Subsequently, if further resources are needed to meet the demand, then unused resources allocated to the tenancy corresponding to the second highest UX can be used, and so on. This may result in achieving a substantially even unused RPMs across one or more or various active tenancies (such as all active tenancies), and results in fair or near fair resource allocation.

There may be scenarios where no (or very few) tenancies have unused resources (e.g., UnX is zero or close or zero for one or more, or most, or all active tenancies), and hence, there may not be any unallocated system level RPMs and/or unused tenancy level RPMs. In such cases, the target RPM of one or more tenancies may be reduced. For example, the target RPM of one or more tenancies having high (such as highest) target RPMs may be reduced, and the freed-up resources may be used to meet the demand of the new requests. In an example, the target RPM of various tenancies may be iteratively reduced, e.g., until the target RPM of the tenancies are substantially the same. In a worst-case scenario, the target RPM of the one or more tenancies may be at the minimum target RPM (MinX).

In an example, when one or more (such as most or all the active tenancies) are operating at or near their corresponding minimum target RPMs, if a request for additional resources is received from a currently active tenancy, such requests may be denied by the GenAI data plane 118 (e.g., see denial of requests from tenancy A at 712_5 of FIG. 7 described below).

In an example, when one or more (such as most or all the active tenancies) are operating at the or near their corresponding minimum target RPMs, if a request for resources is received from a new tenancy (e.g., which was not active so far), resources for such request may be fulfilled by the resources within the grace buffer 458 (e.g., see allocation of resources to new tenancies L and M at 712_6 of FIG. 7 described below).

In an example, reallocation of resources may occur at least in one or more of the following scenarios: (i) a new tenancy sends its initial request, where the reallocation is a request based reallocation, (ii) an active tenancy has its usage reaching a certain high threshold percentage of its allocated resource (e.g., UnA is about 95% of TA, and thus, tenancy A may need new resources), where such reallocation may be done during periodic checkup or updating of the resource allocation table, and/or (iii) a currently active tenancy becomes inactive, where such reallocation may be done during periodic checkup or updating of the resource allocation table.

In an example, when establishing a default minimum target RPM for a new tenancy or increasing the target RPM allocated to an existing active tenant, the allocation of the resources may follow an allocation order in which resources to be allocated are selected. If the required resources cannot be fully obtained from a first source of this allocation order, the remaining amount is then obtained from a second source of the allocation order, and so on. In an example, the allocation order is as follows:

### Allocation Order

1. System level unallocated RPM (UaSys),
2. RPM allocated to, but unused by, various tenancies (e.g., UnX for tenancy X), such as from tenancies with the most unused resources to the tenancies with the least unused resources,
3. Used RPM from active tenants, from tenancies with the most usage to tenancies with the least usage.

The allocation order will be described below (e.g., with respect to FIGS. 6 and 7) in further detail.

In an example, no single tenancy may be allowed to use higher than a threshold percentage of the total available system level RPM. For example, if this threshold percentage is set to 40%, then no single tenancy may be allowed to use higher than 40% of the total available system level RPM. In an example, such a hard limit may be used to prevent abuse and resource hogging by a single tenancy, or a small group of tenancies. This threshold percentage may be configurable by the provider of the GenAI service. In an example, this threshold percentage is fixed. In another example, this threshold percentage may be adjusted based on demand (e.g., during high demand period, this threshold percentage is kept low; and during low demand period, this threshold percentage may be increased opportunistically).

In an example, if requests are received from more than one tenancy, the available resources are distributed in a fair or at least near-fair manner. For example, assume “resources that can be reallocated” refers to any available resources that can be distributed to the one or more requesting tenancies, where the resources that can be reallocated can be UaSys resources and/or unused resources from one or more tenancies. In an example, an amount of resource allocated to a tenancy X is given by:

$$Resource allocated to tenancy X during a current allocation cycle = ( RPM requested by tenancy X during the current allocation cycle ) / ( sum of all requested RPMs from various tenancies during the current allocation cycle ) * resources that can be reallocated . \qquad Equation 4$$

Thus, equation 4 ensures that the tenancies get their fair share of resources.

In an example, when the GenAI data plane 118 has multiple active tenancies and one or more (such as most or all) of the active tenancies are fully using their allocated resources (e.g., UnX is substantially zero for all active tenancies), and additionally when there is no system level unallocated RPM (UaSys), there is no unused or unallocated resource for allocation, either in the system level (e.g., UaSys) or in tenancy level (UnX for tenancy X). In such a scenario, the GenAI data plane 118 starts throttling and scaling down the tenant target allocated RPM (e.g., when additional resources are requested by active tenancies). In an example, the tenancy with highest allocated target RPM is throttled and scaled down first, followed by the tenancy with the second highest allocated target RPM, and so on. This process continues, and if the resource demand keeps on increasing, one or more (such as most or all) the tenancies operate at the minimum target RPM (which is MinX for tenancy X).

In an extreme example where all tenancies operate at the minimum target RPM, no resources can be spared for allocation to active tenancies. As described above, in such an example, a resource request from a new tenancy can be at least in part fulfilled from resources within the grace buffer 458 (e.g., if the grace buffer 458 has available resource for allocation). If the grace buffer 458 is empty, requests from even new tenancies are rejected, as described below.

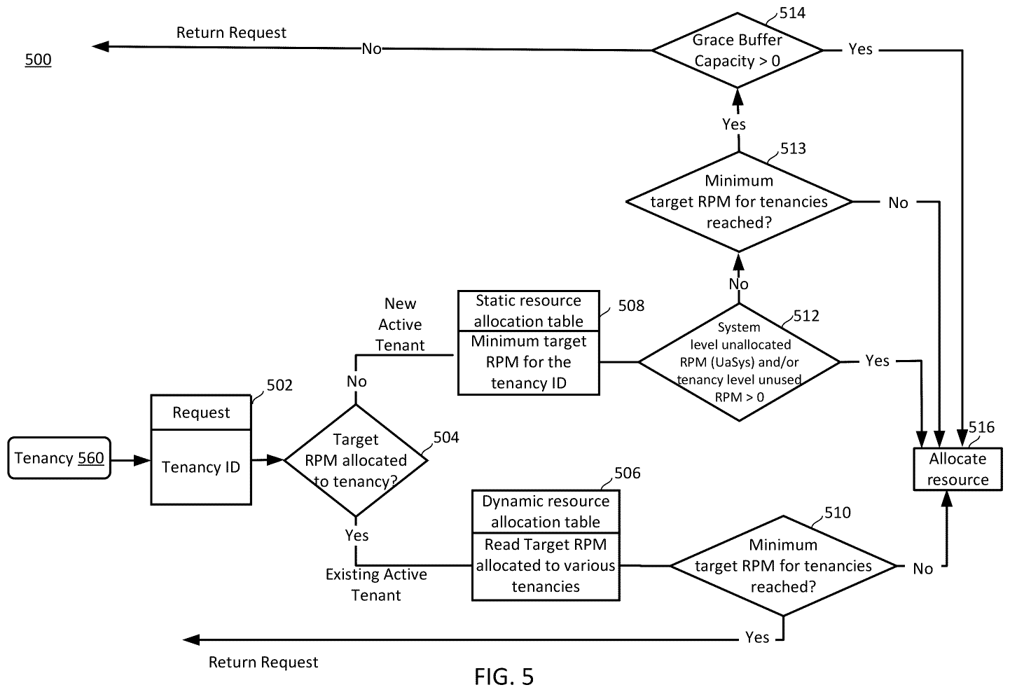

FIG. 5 illustrates an example flowchart 500 for allocating, throttling, or rejecting a request from a tenancy. At block 502, a new request is received from a tenancy 560, which may be any of the tenancies 160a, . . . , 160n of FIG. 1. In one example, the tenancy 560 may be an existing active tenancy, such that resources have been currently allocated to the requesting tenancy, and the target RPM allocated to the tenancy is currently non-zero (such as one of the tenancies A, . . . , E of FIG. 3). In another example, the tenancy 560 may be a new tenancy or currently inactive tenancy, such that resources have not been currently allocated to the requesting tenancy, and the target RPM allocated to the tenancy is currently zero (such as one of the tenancies F, . . . , N of FIG. 3).

The method 500 proceeds from 502 to 504. At 504, the GenAI data plane 118 (such as the resource allocation service 150) determines if a target RPM is currently allocated to the requesting tenancy. If “Yes” at 504, this implies that the requesting tenancy is an existing active tenancy, and the method proceeds from 504 to 506.

At 506, the GenAI data plane 118 (such as the resource allocation service 150) reads the current or most recent resource allocation table, such as a dynamic resource allocation table. For example, the GenAI data plane 118 reads the target RPM allocated to various tenancies (e.g., reads TX, for all active tenancies having non-zero TX).

At 510, the GenAI data plane 118 checks to see if the minimum target RPMs for one or more tenancies (such as all active tenancies) has been reached. For example, if for a given tenancy X, the target RPM TX allocated to the tenancy X is equal to the minimum target RPM MinX for the tenancy X (e.g., TX=MinX for all active tenancies), this implies that the minimum target RPM has been reached for tenancy X. As described below, if (i) the minimum target RPM has been reached for all active tenancies, and (ii) the system level unallocated RPM (UaSys) is zero, there is no additional resource for allocation to the requesting tenancy (e.g., assuming that the requesting tenancy is an existing active tenancy). Note that the minimum target RPM may reach for all tenancies after the system level unallocated RPM (UaSys) is zero, as will be described below.

Hence, if “Yes” at 510, the minimum target RPM has been reached for all active tenancies, and the request from the currently active tenancy is throttled and returned, without any additional allocation of resource to the currently active tenancy, as illustrated in FIG. 5.

On the other hand, if “No” at 510, this implies that the minimum target RPM has not reached for all active tenancies. There may be many scenarios where this may be possible, such as (i) system unallocated resource is non-zero, (ii) one or more tenancies have unused resources, or (iii) system unallocated resource and unused resources of the active tenancies are zero, the active tenancies have only used resources, but such used resources are higher than the minimum target RPM.

If the system unallocated resource (UnSys) is non-zero, then the system unallocated resource may be used to fulfill the resource request. If one or more tenancies have unused resources, then the unused resources of the one or more tenancies may be used to fulfill the resource request.

If the system unallocated resource and unused resources of the active tenancies are zero, the active tenancies have only used resources, and such used resources are higher than the minimum target RPM, then tenancies that have higher amount of allocated resources (e.g., higher than the minimum target RPM) are selected, and resources from the selected tenancies are reallocated to a requesting tenancy (this is illustrated in 712_1 and 716_2 of FIG. 6 described below, where used resources form tenancy E is allocated to one or more other tenancies).

Accordingly, if “No” at 510 (e.g., the minimum target RPM has not reached for all active tenancies), the method 500 proceeds from 510 to 516, where the GenAI data plane 118 allocates resources to the requesting currently active tenancy.

Referring again to block 504, if “No” at 504, this implies that the requesting tenancy is a new tenancy (or currently inactive tenancy), such that resources have not been currently allocated to the requesting tenancy. In such a case, the method proceeds from 504 to 508. At 508, a static configuration of the resource allocation table is read, to identify a minimum target RPM for the tenancy ID. For example, if the requesting tenancy is tenancy X, then the minimum target RPM MinX for tenancy X is read from a static resource allocation table. Note that if resources are available, the new tenancy may initially be allocated at least the minimum target RPM. Subsequently, if requested and if resources are available, the tenancy may be allocated additional resources.

Note that in an example, the resource allocation table of process 506 has to be a recent (such as a most recent) resource allocation table, as the target RPM allocated to various tenancies change dynamically with time. Accordingly, the resource allocation table of process 506 is referred to as a “dynamic” resource allocation table.

In contrast, the resource allocation table of process 508 need not be a most recent or current resource allocation table, because the minimum target RPM MinX is usually static and doesn't generally change with time, as also described above. Accordingly, the resource allocation table of process 508 is referred to as a “static” resource allocation table. In an example, the static resource allocation table may be different from the dynamic resource allocation table, where the static resource allocation table may include static information, such as the minimum target RPM MinX and/or one or more other static resource allocation related information.

However, in another example, the resource allocation tables of processes 506 and 508 may be the same resource allocation table—process 506 reads the most updated or current version of the resource allocation table, whereas process 508 reads information from any available version of the resource allocation table.

The method 500 proceeds from 508 to 512. At 512, the GenAI data plane 118 (such as the resource allocation service 150) estimates if the system level unallocated RPM (UaSys) and/or the tenancy level unused RPM (UnX, for all active tenancies) are greater than zero. Note that instead of comparing with zero, the comparison at 512 can be made with respect to a threshold value. For example, the system level unallocated RPM (UaSys) and/or tenancy level unused RPM can be allocated if either or both of these are at least a threshold value. If the system level unallocated RPM (UaSys) and/or the tenancy level unused RPM are greater than the threshold value (e.g., “Yes” at 512), then there is scope to allocate resources to the requesting new tenancy from these resources. Accordingly, if “Yes” at 512, the method 500 proceeds from 512 to 516, where the GenAI data plane 118 allocates resources to the requesting new tenancy.

Note that if both system level unallocated RPM and tenancy level unused RPM (UnX) for one or more tenancies are greater than the threshold, then initially the system level unallocated RPM is allocated to the new tenancy (e.g., item 1 of the allocation order described above). If system level unallocated RPM is zero and tenancy level unused RPM (UnX) for one or more tenancies are greater than the threshold, then the unused resources from such tenancies are allocated to the new tenancy. For example, resources from a tenancy that has the highest amount of unused resources are first reallocated to the new tenancy. If more resources are needed, resources from a tenancy that has the second highest amount of unused resources are then reallocated to the new tenancy, and this process continues.

On the other hand, if “No” at 512, then no system level unallocated RPM (UaSys) and tenancy level unused RPM are available for allocation to the requesting currently active tenancy. The method 500 then proceeds from 512 to 513.

At 513, the GenAI data plane 118 checks to see if the minimum target RPM for one or more tenancies (such as all active tenancies) has been reached. For example, if for a given tenancy X, the target RPM TX allocated to the tenancy X is equal to the minimum target RPM MinX for the tenancy X, this implies that the minimum target RPM has been reached for tenancy X. As described below, if the minimum target RPM has been reached for all active tenancies, there is no additional resource for reallocation from active tenancies to the new tenancy. Hence, if “Yes” at 513, the minimum target RPM have been reached for all active tenancies, and the method 500 proceeds to 514, where capacity of the grace buffer is checked.

On the other hand, if “No” at 513, this implies that (i) the system unallocated resource and unused resources of the active tenancies are zero, (ii) the active tenancies have only used resources, but (ii) one or more tenancies have used resources that are higher than the minimum target RPM. In such a scenario, one or more tenancies that have higher (or highest) amount of allocated resources (e.g., higher than the minimum target RPM) are selected, and resources from the selected tenancies are reallocated to the new tenancy (this is illustrated in 712_1 and 716_2 of FIG. 6 described below, where used resources form tenancy E is allocated to a new tenancy F). Accordingly, if “No” at 513, the method 500 proceeds from 513 to 516, where the GenAI data plane 118 reallocates resources from one or more active tenancies to the requesting new tenancy.

If “Yes” at 513, the method 500 proceeds from 513 to 514. At 514, the GenAI data plane 118 (such as the resource allocation service 150) estimates if the grace buffer 458 has capacity for allocation of resources to the requesting new tenancy. If “Yes” at 516, the method 500 proceeds from 512 to 516, where the GenAI data plane 118 allocates resources from the grace buffer 458 to the requesting new tenancy.

On the other hand, if “No” at 514, there are no resources available for allocation to the new tenancy. Accordingly, the request from the currently active tenancy is throttled and returned, without any allocation of resources to the new tenancy.

FIG. 6 illustrates a series of resource allocation examples by the GenAI data plane 118 of the cloud environment 102 of FIG. 1. Left side of FIG. 6 illustrates various example incoming requests 612_1, 612_2, . . . , 612_7. FIG. 6 also illustrates resource allocations 616_1, 616_2, . . . , 616_8. One or more of the resource allocations 616_1, . . . , 616_8 may be based on a corresponding preceding request 612. The flow sequence is from top to bottom. For example, request 612_1 is received initially (e.g., during time period t1), followed by request 612_2 (e.g., during time period t2), followed by request 612_3 (e.g., during time period t3), and so on. Similarly, the resource allocation 616_1 occurs initially, followed by resource allocation 616_2, and so on.

Furthermore, the following legends are used for FIG. 6, which have also been described above with respect to FIG. 3. The target RPM allocated to tenancy X is denoted by TX, RPM estimated to be used by tenancy X is denoted by UX, and RPM estimated to be unused by tenancy X is denoted as UnX.

The initial resource allocation 616_1 is, for example, during initialization of the GenAI data plane 118, and no resource of the GenAI data plane 118 has yet been allocated. Accordingly, the GenAI data plane 118 only has system level unallocated RPM (UaSys).

At 612_1, a request for resource allocation is received from tenancy A. Accordingly, in accordance with the above-described allocation order, resources are allocated to tenancy A from the system level unallocated RPM (UaSys), as illustrated in resource allocation 616_2. Thus, in the resource allocation 616_2, UA is the RPM allocated to and used by tenancy A, and UnA is the RPM allocated to but not used by tenancy A. The total target RPM allocated to tenancy A is TA, which is (UA+UnA).

At 612_2, requests for resource allocation are received from tenancies A and B.

Accordingly, in accordance with the above-described allocation order, additional resources are allocated to tenancy A from UaSys and resources are also allocated to tenancy B from UaSys, as illustrated in resource allocation 616_3. For example, the total target RPM TA allocated to tenancy A in the resource allocation 616_3 is higher than the total target RPM TA allocated to tenancy A in the resource allocation 616_2. Thus, additional resources are allocated to the tenancy A. Note that because UaSys is still non-zero, the additional resources to currently active tenancy A and the new resource to new tenancy B are allocated from UaSys.

At 612_3, requests for resource allocation are received from tenancies A, B, C, and D. Note that tenancies A and B are now currently active tenancies, and tenancies C and D are new tenancies. Because there are still system level unallocated resources (UaSys>0), additional resources from UaSys are allocated to tenancies A and B, which increases resource allocation to the tenancies A and B. Also because tenancies C and D are new tenancies, these tenancies may be issued a default amount of resources available for new tenancies (which may be equal to, or greater than the minimum target RPM for each tenancy). The resultant resource allocation 616_4 is illustrated in FIG. 6.

At 612_4, requests for resource allocation are received from tenancies B, C, D, and E. Note that tenancy A has not raised a request at 612_4. At this stage and as illustrated in the resultant resource allocation 616_5, UaSys resources are allocated to the tenancies B, C, D, E. As a result, UaSys resources are now zero, and more resources may be needed for allocation. Note that in the above-described allocation order, UaSys was at number one, followed by RPM estimated to be allocated but unused by various tenancies. The tenancy with the highest amount of unused resource at this point in time is tenancy A. Furthermore, tenancy A has not requested any additional resources. Accordingly, in the resource allocation 616_5, at least a subset of unused resource UnA is reallocated to one or more other tenancies, illustrated symbolically using an arrow exiting the UnA box. Thus, the combination of UaSys and the subset of unused resource UnA is used for meeting the resource demand of the request 612_4.

Assume at 612_5, the GenAI data plane 118 estimates no resource usage by the tenancy A. Accordingly, in the resource allocation 6166, used resource for tenancy A (UA) becomes zero, and all resources allocated to tenancy A are unused (UnA).

At 612_6, requests for resource allocation are received from tenancies B, C, D, and E. Note that tenancy A is no longer active (has zero resource usage). Accordingly, at this stage and as illustrated in the resource allocation 616_7, the resources UnA are reallocated to one or more of the tenancies B, C, D, E.

At 612_7, requests for resource allocation are received from tenancies B and E. There are no UaSys resources to be allocated. Accordingly, at this stage and as illustrated in the resource allocation 616_8, unused resources from tenancies C and/or D may be reallocated to one or more of the tenancies B and E (e.g., the second item of the allocation order described above), illustrated symbolically using arrows exiting the UnC and UnD boxes in the resource allocation 616_8.

FIG. 7 illustrates another series of resource allocation examples by the GenAI data plane 118 of the cloud environment 102 of FIG. 1. Note that in FIG. 6, for at least some of the resource allocations, unused resources were available for allocation. In contrast, FIG. 7 illustrates some example scenarios in which resource demand is higher than those in FIG. 6. FIG. 7 also illustrates extreme cases where resource requests are returned due to unavailability of resources for allocation.

Similar to FIG. 6, left side of FIG. 7 illustrates various example incoming requests 712_1, 712_2, . . . , 712_7. Also FIG. 7 illustrates the resource allocations 716_1, 716_2, . . . , 716_7, one or more of which may be responsive to a corresponding request 712. The flow sequence is from top to bottom. For example, request 712_1 is received initially (e.g., during time period ta), followed by request 712_2 (e.g., during time period tb), followed by request 712_3 (e.g., during time period tc), and so on. Similarly, the resource allocation 716_1 occurs initially, followed by resource allocation 716_2, and so on.

Furthermore, the following legends are used for FIG. 7, which have also been described above with respect to FIG. 3. The target RPM allocated to tenancy X is denoted by TX, RPM estimated to be used by tenancy X is denoted by UX, RPM estimated to be unused by tenancy X is denoted as UnX, and minimum target RPM for tenancy X is denoted as MinX.

The initial resource allocation 716_1 is, for example, after resources are allocated to tenancies A, B, C, D, and E. For each active tenancy, at this point in time, there is not any unused resource at a tenancy level (e.g., UnA, . . . , UnE are zero, and TX=UX for X=A, . . . , E), and there is also not any unallocated resource left at the system level (UnSYS=0). Thus, all resources of the GenAI service are used by the tenancies, except for the resources at the grace buffer and the reserved buffer.

At 712_1, requests for resource allocation are received from tenancies A, . . . , F. Note that tenancies A, B, C, D, and E are currently active tenancies, and tenancy F is a new tenancy. Referring to the above-described allocation order, there is no system level unallocated RPM (UaSys). Furthermore, RPM allocated to, but unused by, various tenancies (e.g., UnX for tenancy X) are also zero. Accordingly, at this point, resources are to be allocated from used resources of currently active tenancies, such as tenancies with higher amount of used resources. As seen in resource allocation 716_1, the tenancy E has the higher amount (such as a highest amount) of used resources (e.g., UE>UA, . . . , UD). Accordingly, in the resource allocation 716_2, currently used resources of tenancy E is allocated to at least the new tenancy F. In an example, currently used resources of tenancy E may also be allocated to one or more other tenancies A, B, C, and D, which have also requested resources at 712_1. Accordingly, this brings some parity between resource used by tenancy UE and resources used by one or more other active tenancies A, . . . , D. For example, due to reallocation of resources from tenancy E to one or more other active tenancies A, D, differences between UE and each of one or more of UA, . . . , UD are decreased, thereby bringing some level of fairness to resource allocation. Thus, resource hogging by tenancy E may be reduced.

At 712_2, requests for resource allocation are received from tenancies A, . . . , G. Note that tenancies A, B, C, D, E, and F are currently active tenancies, and tenancy G is a new tenancy. Referring to the above-described allocation order, there is no system level unallocated RPM (UaSys). Furthermore, RPM allocated to, but unused by, various tenancies (e.g., UnX for tenancy X) are also zero. Accordingly, at this point, resources are to be allocated from used resources of currently active tenancies, such as tenancies with higher amount of used resources. As seen in resource allocation 716_2, the tenancy E still has the higher (or highest) amount of used resources (e.g., UE>UA, . . . , UD, UF). Accordingly, in the resource allocation 716_3, currently used resources of tenancy E is allocated to at least the new tenancy G. In an example, currently used resources of tenancy E may also be allocated to one or more other tenancies B, C, D, and F, which have also requested resources at 712_2. Note that the tenancy with the second highest amount of resource is tenancy A, for example. Thus, prior to the requests at 7122, UE>UA>UB, UC, UD, UF. Accordingly, resource from tenancy E is initially used up to fulfill the requests at 712_2, resulting in decrease of resource of tenancy E. Once the resource of tenancy E becomes equal to that of tenancy A, then resources from both tenancies A and E can be used to fulfill the requests at 712_2, as symbolically illustrated using arrows going out from the UA and UE blocks.

At 7123, requests for resource allocation are received from tenancies A, . . . , H, with tenancy H being a new tenancy. The above-described process of allocating resources from used resources of active tenancies continues. For example, between 712_3 and 712_4, multiple new tenancies are allocated resources. As a result, used resources of active tenancies decrease, until a minimum target resource (e.g., MinX for tenancy X) is reached for one or more (such as most or all) the active tenancies A, . . . , K, as seen in resource allocation 716_5. Thus, in the resource allocation 716_5, UA=MinA, UB=MinB, . . . , UK=MinK, and all active tenancies are operating at the minimum target RPM levels.

At 712_5, requests for resource allocation are received from currently active tenancies A, . . . , K. Note that at this point, all active tenancies A, . . . , K are operating at minimum target resource. Thus, resources allocated to any of the active tenancies A, . . . , K cannot be decreased further. Also, as the requests at 712_5 are from currently active tenancies, resource form the grace buffer cannot be used either. Accordingly, the requests at 712_5 are rejected and returned. Thus, for the rejection of the requests at 7125, the flow follows the blocks 502, 504 (“Yes” at 504), 506, and 510 (“Yes” at 510) of the method 500 of FIG. 5.

At 712_6, requests for resource allocation are received from currently active tenancy A and new tenancies L and M. As described above, at this point, all active tenancies A, . . . , K are operating at minimum target resource (e.g., MinX for tenancy X). Thus, for reasons described above, the request for resource from currently active tenancy A is rejected and returned, and the request and rejection flow associated with the tenancy A follow the blocks 502, 504 (“Yes” at 504), 506, and 510 (“Yes” at 510) of the method 500 of FIG. 5.

On the other hand, the tenancies L and M are new tenancies. Although no unallocated system resource UaSys or unused/used resources of the active tenancies A, . . . , K can be allocated to the new tenancies L and M (e.g., as all active tenancies are running at minimum target resource), resources of the grace buffer 458 can be used to cater to the new tenancies L and M. For example, immediately prior to 712_6, the grace buffer 458 didn't have any of its resources allocated. Accordingly, subsequent to the requests at 712_6, in the resource allocation 716_6, grace buffer resources are shared among the new tenancies L and M. Thus, FIG. 7 shows the grace buffer including UL and UM, which are resources used by tenancies L and M. The request and allocation flow associated with the new tenancies L and M at 712_6 follow the blocks 502, 504 (“No” at 504), 508, 512 (“No” at 512), 513 (“Yes” at 513), and 514 (“Yes” at 514) of the method 500 of FIG. 5.

At 712_7, requests for resource allocation are received from currently active tenancy A and a new tenancy N. As described above, at this point, all active tenancies A, . . . , K are operating at minimum target resource (e.g., MinX for tenancy X). Thus, for reasons described above, the request for resource from currently active tenancy A is rejected and returned, and the request and rejection flow associated with the tenancy A follows the blocks 502, 504 (“Yes” at 504), 506, and 510 (“Yes” at 510) of the method 500 of FIG. 5.

Also, although the tenancy N is new, the grace buffer is also full at this point in time. Accordingly, the request for resource from tenancy N is also rejected and returned. The request and rejection flow associated with the new tenancy N at 712_7 follow the blocks 502, 504 (“No” at 504), 508, 512 (“No” at 512), 513 (“Yes” at 513), and 514 (“No” at 514) of the method 500 of FIG. 5.

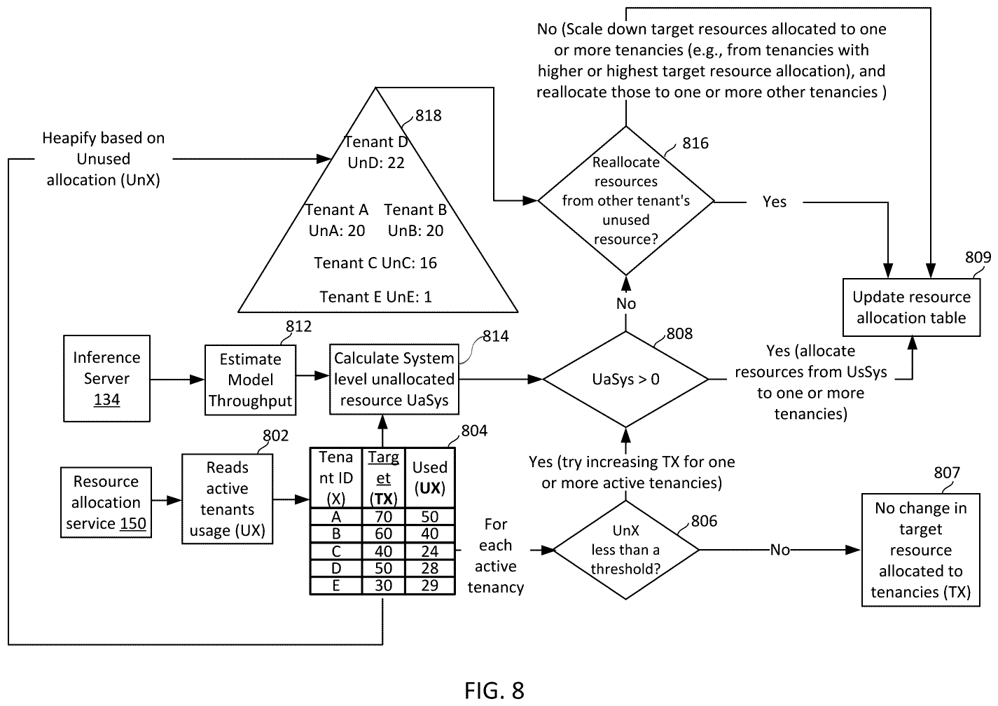

FIG. 8 is a block diagram illustrating an example method 800 for dynamically updating a resource allocation table that is usable to allocate resources to tenancies. While the method 500 is directed towards allocating resources based on resource requests from tenancies and used the resource allocation table in the process, the method 800 is directed towards dynamically updating the resource allocation table. The method 800 may be performed at periodic or aperiodic intervals (such as every 10 seconds, or 30 seconds, or 1 minute, for example). In an example, the method 800 may be performed independent of resource requests received from one or more tenancies.

Referring to FIG. 8, at 802, the resource allocation service 150 reads resources estimated to be used by currently active tenancies (e.g., reads UX, where X corresponds to identifiers of active tenancies), and stores the information in a table 804. In an example and as also described above, there are a plurality of instances of the API server 125, and individual API server 125 may execute a corresponding resource allocation service 150 in a distributed manner. In an example, each instance of the resource allocation service 150 residing in an API server has a local cached copy of this table 804. Each instance of the resource allocation service 150 may periodically broadcast its usage data to its peers (such as to the other instances of the of the resource allocation service 150), e.g., to ensure the instances have the same global view of resource usage.

The resource allocation service 150 may access usage information of the active tenancies from an appropriate source, such as from the GenAI data plane 118. In an example, the resource allocation service 150 stores the table 804 with usages by the active tenancies. The table 804 can be same as, or different from, the resource allocation table. The table 804 also stores the target resources (such as target RPMs) allocated to various active tenancies (e.g., TX, where X corresponds to identifiers of active tenancies). Example values of RPMs illustrated in the table 804 are mere examples.

Also, at 812, the inference server 134 estimates total GenAI model throughput, e.g., using equation 1 described above. At 814, the resource allocation service 150 calculates system level unallocated resource UaSys. For example, the system level unallocated resource UaSys is calculated using equation 3 described above (e.g., using the estimate model throughput of 812 and the target resource allocation of the table 804).

Also, at 818, a heapify process is performed on a list of the active tenancies, e.g., to order the tenancies based on the unused resources of the tenancies (e.g., order the active tenancies based on UnX, where X represents the identifiers of active tenancies). In the example of FIG. 8, tenancies having higher amount of unused resources are listed higher in the order. For example, in the example of FIG. 8, tenancy D has the highest amount of unused resource UnD, which is 22 RPM, followed by 20 RPM of unused resources of tenancies A and B, and so on.

At 806, it is determined whether, for each active tenancy, unused resource (e.g., UnX, where X is the identifier of active tenancies) is less than a threshold. For example, the unused resources of individual tenancies may be determined using the table at 804 (e.g., UnX=TX−UX, see equation 2 above). In one example, the threshold at 806 may be a fixed threshold, e.g., expressed in terms of RPM (such as 5 RPM, or 10 RPM, or the like). In another example, the threshold at 806 may be expressed as a percentage of the target resource allotment to an active tenancy (e.g., maybe 5% or 10% of the target resource allotment TX of an active tenancy). Thus, the process 806 aims to ensure that, if possible, each tenancy has some unused bandwidth or unused (and allocated) resource to suddenly increase its usage of GenAI resource.

In yet another example, the threshold at 806 may be set to zero. Thus, in such an example, reallocation to additional resources to a tenancy is done only after the tenancy has used up all its resources.

In the example of FIG. 8, the tenancy E has an unused resource UnE of 1 RPM (e.g., TE=30 RPM, UE=29 RPM, so UnE=30−29=1 RPM). Accordingly, if the threshold at 806 is, for example, 5 RPM or 10%, then at 806, it may be determined that tenancy E has unused resource UnE less than the threshold, and other tenancies have unused resources that are more than the threshold.

If “No” at 806, then there are sufficient unused resources at each tenancy, and hence, no updating of the resource allocation table may be desirable. Hence, the method 800 proceeds to 807, where no change in target resource allocated to tenancies (TX) is made at 807. Subsequent to 807, the method 800 may keep on repeating at periodic or aperiodic intervals.

However, if “Yes” at 806, there may not be sufficient unused resources at active every tenancy, and hence, it may be desirable to update the resource allocation table (e.g., if resources are available to be relocated to the tenancies that don't have sufficient unused resources). In such an example, the method 800 proceeds from 806 to 808.

At 808, a determination is made as to whether the system level unallocated resource UaSys is greater than zero. If “Yes” at 808, then at least a portion of the system level unallocated resource UaSys may be allocated to tenancies that may not have sufficient unused resources (such as tenancy E). Accordingly, the method 800 proceeds to 809, where the resource allocation table is updated to allocate resources from the system level unallocated resource UsSys to one or more tenancies that may not have sufficient unused resources.

However, if “No” at 808, then there may not be sufficient system level unallocated resource UaSys for allocation. Accordingly, the method 800 proceeds from 808 to 816.

At 816, a determination is made as to whether resources from other tenant's unused resource may be allocated to the one or more tenancies that may not have sufficient unused resources (such as tenancy E). For example, if a tenancy has unused resources of higher than a high threshold value, then the tenancy may be deemed appropriate for donating its unused resources to one or more other tenancies lacking sufficient unused resources. In an example, this high threshold value of 816 may be higher than the threshold of 806. For example, the high threshold at 816 may be a fixed high threshold, e.g., expressed in terms of RPM (such as 10 RPM, or 15 RPM, or the like). In another example, the threshold at 806 may be expressed as a percentage of the target resource allotment to an active tenancy (e.g., maybe 15% or 20% of the target resource allotment TX of an active tenancy). Thus, the process 816 aims to select one or more tenancies having sufficiently high unused resources. The ordered list of tenancies (e.g., ordered based on the unused resources) at 818 may be used at 816 to select zero, one, or more tenancies having sufficiently high resources that may be used for reallocation. For example, if the high threshold is set to 21 RPM, then tenancy D would be deemed to have sufficient unused resources, which may be reallocated to one or more tenancies that may not have sufficient unused resources (such as tenancy E). In another example, if the high threshold is set to 18 RPM, then tenancies D, A, and B would be deemed to have sufficient unused resources, which may be reallocated to one or more tenancies that may not have sufficient unused resources (such as tenancy E).

If “Yes” at 816, the method 800 proceeds from 816 to 809, where the resource allocation table is updated to allocate resources from one or more tenancies having sufficient unused resources (such as tenancy D, and if needed, tenancies A and B) to one or more tenancies that may not have sufficient unused resources (such as tenancy E).

If “No” at 816, this implies none of the tenancies have sufficient unused resources to spare. This may occur if the unused resources of each of the active tenancies may be lower than the high threshold. In such a scenario, target resources allocated to one or more tenancies (e.g., tenancies with higher or highest target resource allocation) are relocated to one or more tenancies with lower target resource allocation and/or with insufficient unused resources (such as tenancy E). Accordingly, the resource allocation table is updated at 809. This results in a fair or near fair distribution of GenAI resources among the various tenancies.

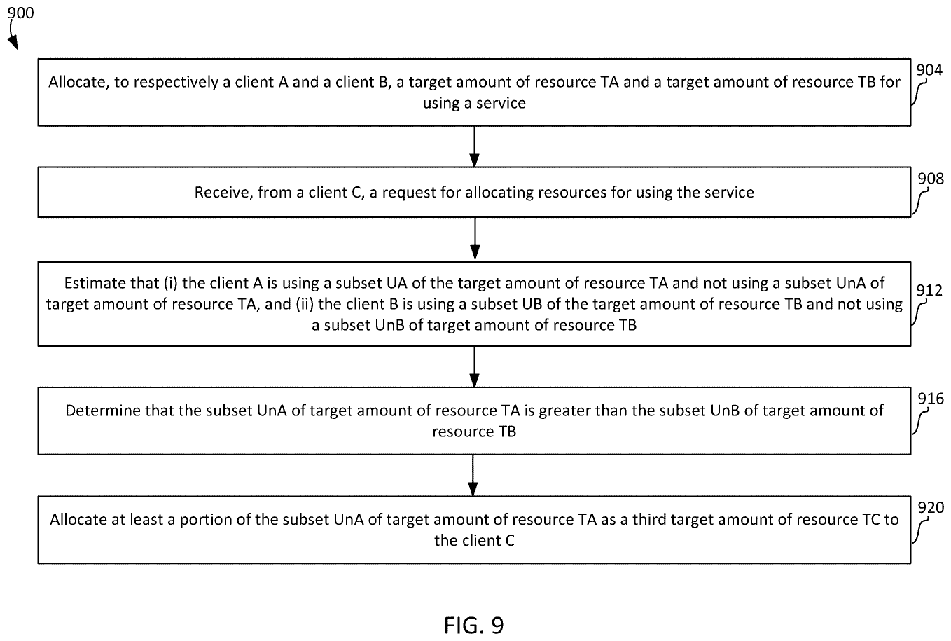

FIG. 9 is a flow diagram depicting a method 900 for allocating resources for accessing a service provided by a cloud provider, such as a GenAI service provided by the cloud provider.

At 904 of the method 900, a target amount of resource TA and a target amount of resource TB are allocated respectively to a client A and a client B, and for using the service. As described above, the resources TA and TB may be measured in terms of RPM, RPT, TPM, TPT, or the like.

The method 900 proceeds from 904 to 908. At 908, a request for allocating resources for using the service is received from a client C. In an example, the client C may be a new client. In another example, the client C may be a currently active client.

The method 900 proceeds from 908 to 912. At 912, it is estimated that (i) the client A is using a subset UA of the target amount of resource TA and not using a subset UnA of target amount of resource TA, and (ii) the client B is using a subset UB of the target amount of resource TB and not using a subset UnB of target amount of resource TB.

The method 900 proceeds from 912 to 916. At 916, a determination is made that the subset UnA of target amount of resource TA is greater than the subset UnB of target amount of resource TB. In an example, among all active clients, client A may have the highest amount of unused resource (e.g., UnA is highest among all UnX, where X represents identifiers of all active tenancies). In an example, it may also be determined that the system level unused resource UaSys is also zero or less than a threshold value, and hence, sufficient resources from UaSys cannot be allocated to the client C. Accordingly, a portion of UnA may be allocated to the client C.

The method 900 proceeds from 916 to 920. At 920, at least a portion of the subset UnA of target amount of resource TA is allocated as a third target amount of resource TC to the client C. Examples of such reallocation of unused resources of one client to one or more other clients have been described above, e.g., with respect to FIG. 7 (where resources from tenancies E and A were reallocated to other tenancies).

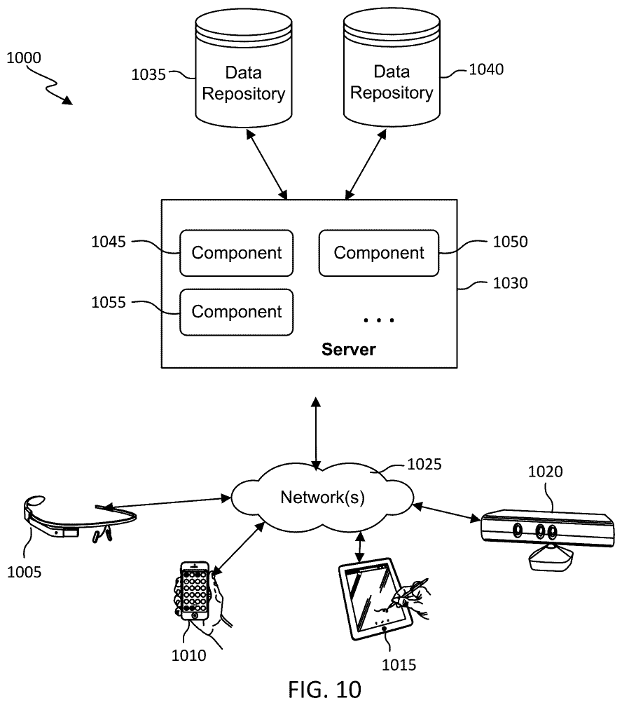

FIG. 10 illustrates a simplified diagram of an example distributed system 1000 for a cloud hosting a GenAI platform. In the illustrated example, distributed system 1000 includes one or more client computing devices 1005, 1010, 1015, and 1020, coupled to a server 1030 via one or more communication networks 1025. Clients computing devices 1005, 1010, 1015, and 1020 may be configured to execute one or more applications interact with the server 1030 to access and utilize the GenAI platform securely integrated within a cloud environment, such as Oracle cloud integrated with Cohere. Within this framework, server 1030 is configured to host and manage a range of services or software applications, facilitating seamless integration and operation of the GenAI platform.

In various aspects, server 1030 may extend its capabilities to encompass additional services or software applications. These services may span both virtual and non-virtual environments, enabling a comprehensive and adaptable infrastructure for securely deploying GenAI solutions within the cloud ecosystem. In some respects, these services may be offered as web-based or cloud services, such as under a Software as a Service (SaaS) model to the users of client computing devices 1005, 1010, 1015, and/or 1020. Users operating client computing devices 1005, 1010, 1015, and/or 1020 may in turn utilize one or more client applications to interact with server 1030 to utilize the services provided by these components. Furthermore, client computing devices 1005, 1010, 1015, and/or 1020 may in turn utilize one or more client applications to initiate and manage specific tasks or analyses within the GenAI platform.

In the configuration depicted in FIG. 10, server 1030 may include one or more components 1045, 1050 and 1055 that implement the functions performed by server 1030. These components may include software components that may be executed by one or more processors, hardware components, or combinations thereof. It should be appreciated that various different system configurations are possible, which may be different from distributed system 1000. The examples shown in FIG. 10 are thus examples of a distributed system for implementing an example system and is not intended to be limiting.

Users may initiate requests for the GenAI platform through client computing devices 1005, 1010, 1015, and/or 1020 for inference or other machine-learning tasks. A client device may provide an interface that enables a user of the client device to interact with the GenAI platform. The client device may also output information to the user via this interface. Although FIG. 10 depicts only four client computing devices, any number of client computing devices may be supported providing scalability and accessibility within the integrated GenAI platform on the cloud.

The client devices may include various types of computing systems, such as portable handheld devices, general purpose computers, such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows©, Apple Macintosh®, UNIX® or UNIX-like operating systems, Linux or Linux-like operating systems, such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various applications, such as various Internet-related apps, communication applications (e.g., E-mail applications, short message service (SMS) applications) and may use various communication protocols.

Network(s) 1025 may be any type of network familiar to those skilled in the art that can support data communications using any of a variety of available protocols, including without limitation TCP/IP (transmission control protocol/internet protocol), SNA (systems network architecture), IPX (internet packet exchange), AppleTalk®, and the like. Merely by way of example, network(s) 1025 can be a local area network (LAN), networks based on ethernet, token-ring, a wide-area network (WAN), the internet, a virtual network, a virtual private network (VPN), an intranet, an extranet, a public switched telephone network (PSTN), an infra-red network, a wireless network (e.g., a network operating under any of the institute of electrical and electronics (IEEE) 1002.11 suite of protocols, Bluetooth®, and/or any other wireless protocol), and/or any combination of these and/or other networks.

Server 1030 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1030 can include one or more virtual machines running virtual operating systems, or other computing architectures involving virtualization, such as one or more flexible pools of logical storage devices that can be virtualized to maintain virtual storage devices for the server. In various aspects, server 1030 may be adapted to run one or more services or software applications that provide the functionality described in the foregoing disclosure.

The computing systems in server 1030 may run one or more operating systems including any of those discussed above, as well as any commercially available server operating system. Server 1030 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

Distributed system 1000 may also include one or more data repositories 1035, 1040. Data repositories 1035, 1040 may reside in a variety of locations. For example, a data repository used by server 1030 may be local to server 1030 or may be remote from server 1030 and in communication with server 1030 via a network-based or dedicated connection. Data repositories 1035, 1040 may be of different types. In certain aspects, a data repository used by server 1030 may be a database, for example, a relational database, such as databases provided by Oracle Corporation® and other vendors. One or more of these databases may be adapted to enable storage, update, and retrieval of data to and from the database in response to structured query language (SQL)-formatted commands. In certain aspects, one or more data repositories 1035, 1040 may also be used by applications to store application data. The data repositories used by applications may be of different types, such as, for example, a key-value store repository, an object store repository, or a general storage repository supported by a file system.

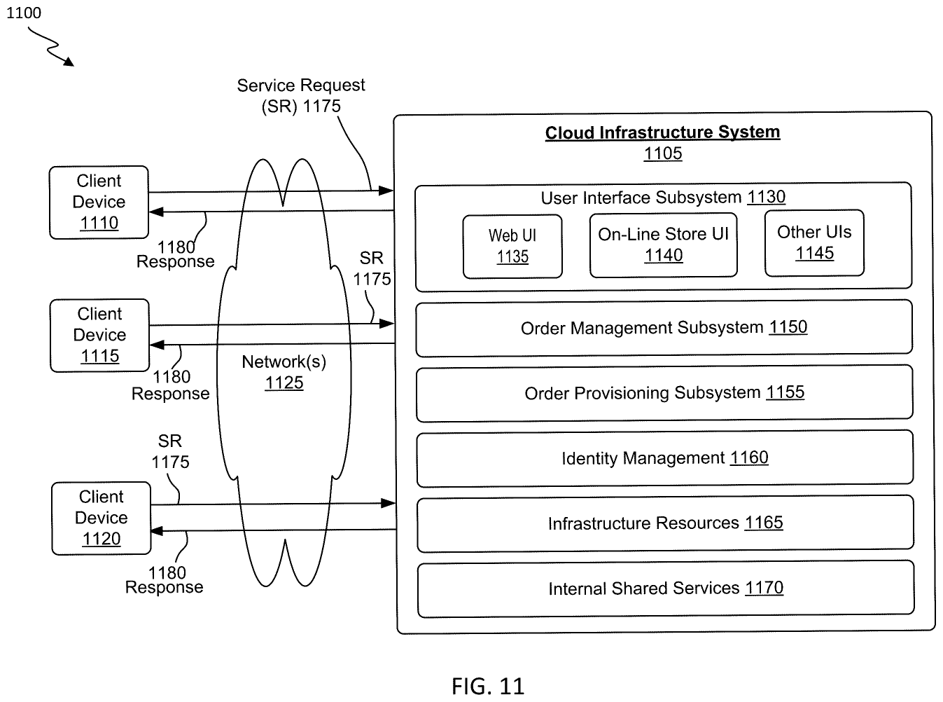

FIG. 11 is a simplified block diagram of a cloud-based system environment in which various services of server 1030 of FIG. 10 may be offered as cloud services, in accordance with certain aspects. In the illustrative example depicted in FIG. 11, cloud infrastructure system 1105 may provide one or more cloud services that may be requested by users using one or more client devices 1110, 1115, and 1120. Cloud infrastructure system 1105 may comprise one or more computers and/or servers that may include those described for server 1030. The computers in cloud infrastructure system 1105 may be organized as general-purpose computers, specialized server computers, server farms, server clusters, or any other appropriate arrangement and/or combination.

Network(s) 1125 may facilitate communication and exchange of data between clients 1110, 1115, and 1120 and cloud infrastructure system 1105. Network(s) 1125 may include one or more networks. The networks may be of the same or different types. Network(s) 1125 may support one or more communication protocols, including wired and/or wireless protocols, for facilitating the communications.

The illustrative example depicted in FIG. 11 is only one example of a cloud infrastructure system 1105 and is not intended to be limiting. It should be appreciated that, in some other aspects, cloud infrastructure system 1105 may have more or fewer components than those depicted in FIG. 11, may combine two or more components, or may have a different configuration or arrangement of components. For example, although FIG. 11 depicts three client computing devices, any number of client computing devices may be supported in alternative aspects.

The term cloud service is generally used to refer to a service that is made available to users on demand and via a communication network, such as the internet by systems (e.g., cloud infrastructure system 1105) of a service provider. Typically, in a public cloud environment, servers and systems that make up the cloud service provider's system are different from the client's own on-premises servers and systems. The cloud service provider's systems are managed by the cloud service provider. Clients can thus avail themselves of cloud services provided by a cloud service provider without having to purchase separate licenses, support, or hardware and software resources for the services. For example, a cloud service provider's system may host an application, and a user may, via a network 1125 (e.g., the internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 1105 may provide one or more cloud services using different models, such as under a Software as a Service (SaaS) model, a Platform as a Service (PaaS) model, an Infrastructure as a Service (IaaS) model, and others, including hybrid service models. Cloud infrastructure system 1105 may include a suite of applications, middleware, databases, and other resources that enable provision of the various cloud services.

A SaaS model enables an application or software to be delivered to a client over a communication network like the Internet, as a service, without the client having to buy the hardware or software for the underlying application. For example, a SaaS model may be used to provide clients access to on-demand applications that are hosted by cloud infrastructure system 1105. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a client as a cloud service to provide elastic compute and storage capabilities. Various IaaS services are provided by Oracle Corporation®.

A PaaS model is generally used to provide, as a service, platform and environment resources that enable clients to develop, run, and manage applications and services without the client having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a client, via a subscription order, may order one or more services provided by cloud infrastructure system 1105. Cloud infrastructure system 1105 then performs processing to provide the services requested in the client's subscription order. Cloud infrastructure system 1105 may be configured to provide one or even multiple cloud services.

Cloud infrastructure system 1105 may provide cloud services via different deployment models. In a public cloud model, cloud infrastructure system 1105 may be owned by a third-party cloud services provider and the cloud services are offered to any general public client, where the client can be an individual or an enterprise. In certain other aspects, under a private cloud model, cloud infrastructure system 1105 may be operated within an organization (e.g., within an enterprise organization) and services provided to clients that are within the organization. For example, the clients may be various departments of an enterprise, such as the Human Resources department, the payroll department, etc. or even individuals within the enterprise. In certain other aspects, under a community cloud model, the cloud infrastructure system 1105 and the services provided may be shared by several organizations in a related community. Various other models, such as hybrids of the above-mentioned models may also be used.

Client computing devices 1110, 1115, and 1120 may be of several types (such as devices 1005, 1010, 1015, and 1020 depicted in FIG. 10) and may be capable of operating one or more client applications. A user may use a client device to interact with cloud infrastructure system 1105, such as to request a service provided by cloud infrastructure system 1105. For instance, a user might employ a client device to execute real-time data querying operations within the cloud. A GenAI client may use a client device, such as a laptop to interact with the GenAI platform integrated within cloud infrastructure system. The client may request GPU-accelerated computing instances of the cloud for training deep learning models. The cloud may provide the necessary resources, and the GenAI client may monitor and manage the training process through the laptop. Upon completion, the client may retrieve the trained models and results.

In certain aspects, to facilitate efficient provisioning of these resources for supporting the various cloud services provided by cloud infrastructure system 1105 for different clients, the resources may be bundled into sets of resources or resource modules (also referred to as “pods” or GenAI serving pods 520). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1105 may comprise multiple subsystems. These subsystems may be implemented in software, or hardware, or combinations thereof. As depicted in FIG. 11, the subsystems may include a user interface subsystem 1130 that enables users or clients of cloud infrastructure system 1105 to interact with cloud infrastructure system 1105. User interface subsystem 1130 may include various interfaces, such as a web user interface 1135, an online store interface 1140 where cloud services provided by cloud infrastructure system 1105 are advertised and are purchasable by a consumer, and other interfaces 1145. For example, a client may, using a client device, request (service request 1175) one or more services provided by cloud infrastructure system 1105 using one or more of interfaces 1135, 1140, and 1145. For example, a client may access the online store, browse cloud services offered by cloud infrastructure system 1105, and place a subscription order for one or more services offered by cloud infrastructure system 1105 that the client wishes to subscribe to. The service request may include information identifying the client and one or more services that the client desires to subscribe to. For example, a client may place a subscription order for a Chabot related service offered by cloud infrastructure system 1105. As part of the order, the client may provide information identifying for input (e.g., utterances).

In certain aspects, such as the illustrative example depicted in FIG. 11, cloud infrastructure system 1105 may comprise an order management subsystem (OMS) 1150 that is configured to process the new order. As part of this processing, OMS 1150 may be configured to: create an account for the client, if not done already; receive billing and/or accounting information from the client that is to be used for billing the client for providing the requested service to the client; verify the client information; upon verification, book the order for the client; and orchestrate various workflows to prepare the order for provisioning.

Once properly validated, OMS 1150 may then invoke the order provisioning subsystem (OPS) 1155 that is configured to provision resources for the order including processing, memory, and networking resources. The provisioning may include allocating resources for the order and configuring the resources to facilitate the service requested by the client order. The manner in which resources are provisioned for an order and the type of the provisioned resources may depend upon the type of cloud service that has been ordered by the client. For example, according to one workflow, OPS 1155 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting client for providing the requested service.

Cloud infrastructure system 1105 may itself internally use services 1170 that are shared by different components of cloud infrastructure system 1105 and which facilitate the provisioning of services by cloud infrastructure system 1105. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like. As depicted in the illustrative example in FIG. 11, cloud infrastructure system 1105 may include infrastructure resources 1165 that can be utilized for facilitating the provision of various cloud services offered by cloud infrastructure system 1105. Infrastructure resources 1165 may include, for example, processing resources, storage or memory resources, networking resources, and the like. Cloud infrastructure system 1105 may send a response or notification 1180 to the requesting client to indicate when the requested service is now ready for use. In some instances, information (e.g., a link) may be sent to the client that enables the client to start using and availing the benefits of the requested services.

Cloud infrastructure system 1105 may provide services to multiple clients in parallel. Cloud infrastructure system 1105 may store information for these clients, including possibly proprietary information. In certain aspects, cloud infrastructure system 1105 comprises an identity management subsystem (IMS) 1160 that is configured to manage client's information and provide the separation of the managed information such that information related to one client is not accessible by another client. IMS 1160 may be configured to provide various security-related services, such as identity services, such as information access management, authentication and authorization services, services for managing client identities and roles and related capabilities, and the like.

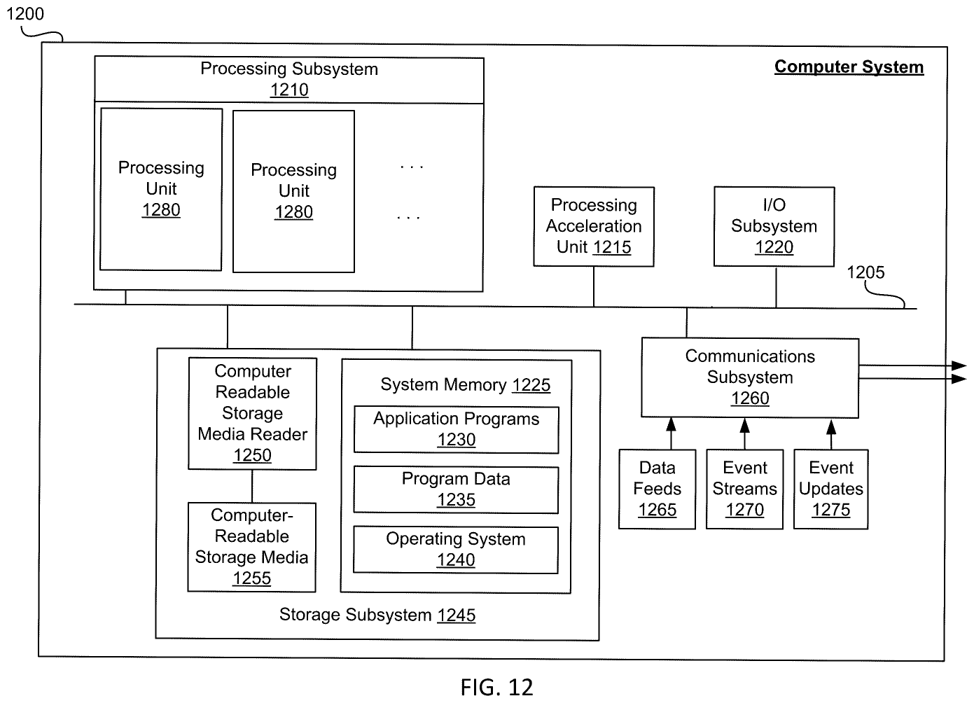

FIG. 12 illustrates an exemplary computer system 1200 that may be used to implement certain aspects of the present disclosure. For example, a computer system 1200 may facilitate the integration of a GenAI platform with the cloud by provisioning and configuring resources, managing data, implementing security measures, monitoring performance, and enabling scalability. It may serve as the foundational infrastructure, enabling seamless deployment and operation of AI applications within the cloud environment while providing flexibility and scalability to adapt to changing computational demands efficiently. In some aspects, computer system 1200 may be used to implement various servers as described above. As shown in FIG. 12, computer system 1200 may include various subsystems including a processing subsystem 1210 that communicates with a few other subsystems via a bus subsystem 1205. These other subsystems may include a processing acceleration unit 1215, an I/O subsystem 1220, a storage subsystem 1245, and a communications subsystem 1260. Storage subsystem 1245 may include non-transitory computer-readable storage media including storage media 1255 and a system memory 1225.

Bus subsystem 1205 provides a mechanism for letting the various components and subsystems of computer system 1200 communicate with each other as intended. Although bus subsystem 1205 is shown schematically as a single bus, alternative aspects of the bus subsystem may utilize multiple buses. Bus subsystem 1205 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1210 controls the operation of computer system 1200 and may comprise one or more processors, application specific integrated circuits (ASICs), or field programmable gate arrays (FPGAs). The processors may include single core or multicore processors. The processing resources of computer system 1200 can be organized into one or more processing units 1280, 1280, etc. A processing unit may include one or more processors, one or more cores from the same or different processors, a combination of cores and processors, or other combinations of cores and processors. In some aspects, processing subsystem 1210 can include one or more special purpose co-processors, such as graphics processors, digital signal processors (DSPs), or the like. In some aspects, some or all of the processing units of processing subsystem 1210 can be implemented using customized circuits, such as application specific integrated circuits (ASICs), or field programmable gate arrays (FPGAs).

In some aspects, the processing units in processing subsystem 1210 can execute instructions stored in system memory 1225 or on computer readable storage media 1255. In various aspects, the processing units can execute a variety of programs or code instructions and can maintain multiple concurrently executing programs or processes. At any given time, some, or all of the program code to be executed can be resident in system memory 1225 and/or on computer-readable storage media 1255 including potentially on one or more storage devices. Through suitable programming, processing subsystem 1210 can provide various functionalities described above. In instances where computer system 1200 is executing one or more virtual machines, one or more processing units may be allocated to each virtual machine.

In certain aspects, a processing acceleration unit 1215 may optionally be provided for performing customized processing or for off-loading some of the processing performed by processing subsystem 1210 to accelerate the overall processing performed by computer system 1200.

I/O subsystem 1220 may include devices and mechanisms for inputting information to computer system 1200 and/or for outputting information from or via computer system 1200. In general, use of the term input device is intended to include all possible types of devices and mechanisms for inputting information to computer system 1200. User interface input devices may include, for example, a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices, such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices, such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices, such as computed tomography, magnetic resonance imaging, position emission tomography, and medical ultrasonography devices. User interface input devices may also include, for example, audio input devices, such as MIDI keyboards, digital musical instruments, and the like.

In general, use of the term output device is intended to include all possible types of devices and mechanisms for outputting information from computer system 1200 to a user or other computer. User interface output devices may include a display subsystem, indicator lights, or non-visual displays, such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics, and audio/video information, such as monitors, printers, speakers, headphones, automotive navigation systems, plotters, voice output devices, and modems.

Storage subsystem 1245 provides a repository or data store for storing information and data that is used by computer system 1200. Storage subsystem 1245 provides a tangible non-transitory computer-readable storage medium for storing the basic programming and data constructs that provide the functionality of some aspects. Storage subsystem 1245 may store software (e.g., programs, code modules, instructions) that when executed by processing subsystem 1210 provides the functionality described above. The software may be executed by one or more processing units of processing subsystem 1210. Storage subsystem 1245 may also provide a repository for storing data used in accordance with the teachings of this disclosure.

Storage subsystem 1245 may include one or more non-transitory memory devices, including volatile and non-volatile memory devices. As shown in FIG. 12, storage subsystem 1245 includes a system memory 1225 and a computer-readable storage media 1255. System memory 1225 may include a number of memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1200, such as during start-up, may typically be stored in the ROM. The RAM typically contains data and/or program modules that are presently being operated and executed by processing subsystem 1210. In some implementations, system memory 1225 may include multiple different types of memory, such as static random-access memory (SRAM), dynamic random-access memory (DRAM), and the like.

By way of example, and not limitation, as depicted in FIG. 12, system memory 1225 may load application programs 1230 that are being executed, which may include various applications, such as Web browsers, mid-tier applications, relational database management systems (RDBMS), etc., program data 1235, and an operating system 1240. By way of example, operating system 1240 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, Palm® OS operating systems, and others.

Computer-readable storage media 1255 may store programming and data constructs that provide the functionality of some aspects. Computer-readable media 1255 may provide storage of computer-readable instructions, data structures, program modules, and other data for computer system 1200. Software (programs, code modules, instructions) that, when executed by processing subsystem 1210 provides the functionality described above, may be stored in storage subsystem 1245. By way of example, computer-readable storage media 1255 may include non-volatile memory, such as a hard disk drive, a magnetic disk drive, an optical disk drive, such as a CD ROM, digital video disc (DVD), a Blu-Ray® disk, or other optical media. Computer-readable storage media 1255 may include, but is not limited to, Zip® drives, flash memory cards, universal serial bus (USB) flash drives, secure digital (SD) cards, DVD disks, digital video tape, and the like. Computer-readable storage media 1255 may also include, solid-state drives (SSD) based on non-volatile memory, such as flash-memory based SSDs, enterprise flash drives, solid state ROM, and the like, SSDs based on volatile memory, such as solid state RAM, dynamic RAM, static RAM, dynamic random access memory (DRAM)-based SSDs, magneto resistive RAM (MRAM) SSDs, and hybrid SSDs that use a combination of DRAM and flash memory based SSDs.

In certain aspects, storage subsystem 1245 may also include a computer-readable storage media reader 1250 that can further be connected to computer-readable storage media 1255. Reader 1250 may receive and be configured to read data from a memory device, such as a disk, a flash drive, etc.

In certain aspects, computer system 1200 may support virtualization technologies, including but not limited to virtualization of processing and memory resources. For example, computer system 1200 may provide support for executing one or more virtual machines. In certain aspects, computer system 1200 may execute a program, such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1200. Accordingly, multiple operating systems may potentially be run concurrently by computer system 1200.

Communications subsystem 1260 provides an interface to other computer systems and networks. Communications subsystem 1260 serves as an interface for receiving data from and transmitting data to other systems from computer system 1200. For example, communications subsystem 1260 may enable computer system 1200 to establish a communication channel to one or more client devices via the Internet for receiving and sending information from and to the client devices. For example, the communication subsystem may be used to transmit a response to a user regarding the inquiry for a Chabot.

Communication subsystem 1260 may support both wired and/or wireless communication protocols. For example, in certain aspects, communications subsystem 1260 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1260 can provide wired network connectivity (e.g., Ethernet) in addition to or instead of a wireless interface.

Communication subsystem 1260 can receive and transmit data in various forms. For example, in some aspects, in addition to other forms, communications subsystem 1260 may receive input communications in the form of structured and/or unstructured data feeds 1265, event streams 1270, event updates 1275, and the like. For example, communications subsystem 1260 may be configured to receive (or send) data feeds 1265 in real-time from users of social media networks and/or other communication services, such as Twitter® feeds, Facebook® updates, web feeds, such as Rich Site Summary (RSS) feeds, and/or real-time updates from one or more third party information sources.

In certain aspects, communications subsystem 1260 may be configured to receive data in the form of continuous data streams, which may include event streams 1270 of real-time events and/or event updates 1275, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1260 may also be configured to communicate data from computer system 1200 to other computer systems or networks. The data may be communicated in various forms, such as structured and/or unstructured data feeds 1265, event streams 1270, event updates 1275, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 1200 depicted in FIG. 12 is intended only as a specific example. Many other configurations having more or fewer components than the system depicted in FIG. 12 are possible. Based on the disclosure and teachings provided herein, a person of ordinary skill in art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claim is:

1. A computer-implemented method comprising:
allocating, to respectively a first client and a second client, a first target amount of resource and a second target amount of resource for using a service;
receiving, from a third client, a request for allocating resources for using the service;
estimating that (i) the first client is using a first subset of the first target amount of resource and not using a second subset of first target amount of resource, and (ii) the second client is using a third subset of the second target amount of resource and not using a fourth subset of second target amount of resource;
determining that the second subset of first target amount of resource is greater than the fourth subset of second target amount of resource; and
allocating at least a portion of the second subset of first target amount of resource as a third target amount of resource to the third client, responsive at least in part to determining that the second subset of first amount of resource is greater than the fourth subset of second amount of resource.

2. The computer-implemented method of claim 1, wherein allocating at least the portion of the second subset of first target amount of resource to the third client comprises:
estimating that a system level amount of unallocated resource, which has not been allocated yet to any client, is less than a threshold value; and
allocating at least the portion of the second subset of first amount of resource to the third client, responsive at least in part to estimating that the system level amount of unallocated resource is less than the threshold value.

3. The computer-implemented method of claim 2, wherein the system level amount of unallocated resource excludes (i) a first buffered amount of resource that is reserved for allocation to one or more new clients, when no other resources are available for allocation to the one or more new clients, and wherein the first buffered amount of resource is not for allocation to any active client using the service, and (ii) a second buffered amount of resource that are not to be explicitly allocated to any new or active client.

4. The computer-implemented method of claim 3, wherein the second buffered amount of resource is to at least in part act as a safety margin, to account for imprecision in resource allotment and/or resource estimation.

5. The computer-implemented method of claim 2, wherein the threshold value is zero.

6. The computer-implemented method of claim 1, wherein the service is usage of an Artificial Intelligence (AI) model.

7. The computer-implemented method of claim 6, wherein the various amounts of resources are measured in terms to requests per timeframe (RPT) or tokens per timeframe (TPT) to the AI model.

8. The computer-implemented method of claim 6, wherein the various amounts of resources are measured in terms to requests per minute (RPM) or tokens per minute (TPM) to the AI model.

9. The computer-implemented method of claim 6, wherein:
the first client is a first tenancy of a cloud environment, the first tenancy hosting a first cloud application that uses the service;
the second client is a second tenancy of the cloud environment, the second tenancy hosting a second cloud application that uses the service;
the third client is a third tenancy of the cloud environment, the third tenancy hosting a third cloud application that uses the service; and
the AI model is hosted by an AI provider tenancy of the cloud environment.

10. The computer-implemented method of claim 1, wherein the request from the third client is received and the third target amount of resource is allocated during a first time period, and wherein the method further comprises:
allocating, during a second time period different from the first time period and for using the service, a first modified target amount of resource and a second modified target amount of resource to respectively the first client and the second client;
receiving, from a fourth client, a request for allocating resources for using the service;
estimating that a system level amount of unallocated resource, which has not been allocated yet to any client, is greater than a threshold value; and
allocating at least a portion of the system level amount of unallocated resource as a fourth target amount of resource to the fourth client.

11. The computer-implemented method of claim 1, wherein the request from the third client is received and the third target amount of resource is allocated during a first time period, and wherein the method further comprises:
receiving, from a fourth client and a fifth client and during a second time period different from the first time period, requests for allocating resources for using the service;
determining that each of a plurality of active clients using the service has been allocated a minimum target resource for using the service, wherein the plurality of active clients include the fourth client and excludes the fifth client;
determining that a buffered amount of resource, which is reserved for allocation to one or more new clients, has a non-zero value;
allocating at least a portion of the buffered amount of resource to the fifth client; and
rejecting the request that was received from the fourth client during the second time period, responsive at least in part to determining that each of the plurality of active clients using the service has been allocated the minimum target resource.

12. The computer-implemented method of claim 1, wherein the request from the third client is received and the third target amount of resource is allocated during a first time period, and wherein the method further comprises:
allocating, during a second time period different from the first time period and for using the service, a fourth target amount of resource and a fifth target amount of resource to respectively a fourth client and a fifth client;
estimating that a portion of the fourth target amount of resource, which is not being used by the fourth client, is less than a low threshold value;
estimating that a portion of the fifth target amount of resource, which is not being used by the fifth client, is more than a high threshold value;
selecting the fifth client for reallocation of resources to the fourth client; and
reallocating a portion of the fifth target amount of resource of the fifth client to the fourth client, responsive at least in part to selecting the fifth client.

13. The computer-implemented method of claim 12, wherein selecting the fifth client for reallocation of resources to the fourth client comprises:
determining that among a plurality of active clients using the service, the fifth client has a highest amount of unused resource; and
selecting the fifth client for reallocation of resources to the fourth client, responsive at least in part to determining that the fifth client has the highest amount of unused resource.

14. The computer-implemented method of claim 1, further comprising:
periodically checking resource allocation of a plurality of active clients using the service;
determining that a first active client of the plurality of active clients has an unused resource amount that is less than a low threshold value;
allocating additional resource to the at least one active client, wherein the additional resource to the at least one active client is allocated form one or more of:
(i) a system level amount of unallocated resource that has not been allocated yet to any active client of the plurality of active clients,
(ii) a second active client that has a highest amount of unused resource among the plurality of active clients, and/or
(iii) a third active client that has a highest amount of allocated resource among the plurality of active clients.

15. A computer-program product comprising one or more non-transitory machine-readable storage media, including stored instructions configured to cause a computing system to perform operations including:
allocating, to respectively a first client and a second client, a first target amount of resource and a second target amount of resource for using a service;
receiving, from a third client, a request for allocating resources for using the service;
estimating that a system level amount of unallocated resource, which has not been allocated yet to any client, is less than a threshold value, wherein the system level amount of unallocated resource excludes (i) a first buffered amount of resource that is reserved for allocation to one or more new clients, when no other resources are available for allocation to the one or more new clients, and wherein the first buffered amount of resource is not for allocation to any active client using the service, and (ii) a second buffered amount of resource that are not to be explicitly allocated to any new or active client; and
allocating at least a portion of the second or fourth subsets to the third client, responsive at least in part to estimating that the system level amount of unallocated resource is less than a threshold value.

16. The computer-program product of claim 15, wherein allocating at least the portion of the second or fourth subsets to the third client comprises:
determining that the second subset of first target amount of resource is greater than the fourth subset of second target amount of resource; and
allocating at least a portion of the second subset of first target amount of resource to the third client, responsive at least in part to determining that the second subset of first amount of resource is greater than the fourth subset of second amount of resource.

17. The computer-program product of claim 15, wherein the service is usage of an Artificial Intelligence (AI) model.

18. A system comprising:
one or more processors; and
a storage to store a resource allocation table that is indicative of one or more of (i) a target resource amount allocated to each of a plurality of active clients, (ii) an estimated amount of used resource currently being used by each active client of the plurality of active clients, (ii) an estimated amount of unused resource currently being allocated and not being used by each active client of the plurality of active clients;
one or more non-transitory computer-readable media storing instructions, which, when executed by the one or more processors, cause the system to perform a set of actions including:
receiving, from an active client of the plurality of active clients and a new client, requests for allocating resources for using a service;
determining, from the resource allocation table, that the target resource amount allocated to each of the plurality of active clients is equal to a minimum target resource for using the service;
determining that a buffered amount of resource, which is reserved for allocation to one or more new clients, has a non-zero value;
allocating at least a portion of the buffered amount of resource to the new client; and
rejecting the request from the active client, responsive at least in part to determining that the target resource amount allocated to each of the plurality of active clients is equal to the minimum target resource for using the service.

19. The system of claim 18, wherein the service is usage of an Artificial Intelligence (AI) model.

20. The system of claim 18, wherein the various amounts of resources are measured in terms to requests per timeframe (RPT) or tokens per timeframe (TPT) to the AI model.
